(19) United States
(12) Patent Application Publication
(10) Pub. No.: US 2008/0167849 A1
(43) Pub. Date: Jul. 10, 2008

(54) Reservoir Simulation

(75) Inventors: Hugh Hales, West Valley, UT (US); Daniel Weber, Provo, UT (US); Ben Hardy, Calgary (CA); Brad Bundy, Mountain View, CA (US); Larry Baxter, Orem, UT (US)

Correspondence Address: JAMES SONNTAG;JAMES SONNTAG, PATENT ATTORNEY, P.O. BOX 9194, SALT LAKE CITY, UT, 84109, US

(73) Assignee: BRIGHAM YOUNG UNIVERSITY, Provo, UT (US)

(21) Appl. No.: 11/570,218

(22) PCT Filed: Jun. 4, 2005
(86) PCT No.: PCT/US05/19358

§ 371 Date: Oct. 15, 2007

Related U.S. Application Data
(60) Provisional application No. 60/577,975, filed on Jun. 7, 2004.

(51) Int. Cl. G06G 7/50

(52) U.S. Cl. 703/10

(57) ABSTRACT

Disclosed are methods for simulating pressures and saturations of oil, gas, and water in an oil reservoir with production and injection wells, which include (1) using of new approximating linear algebraic (finite difference) equations that more accurately represent actual pressures by basing the equations on new functional forms: ln(r) or 1/r, (2) solve the set equations using by defining a coarse grid array and a fine grid array nested in the fine grid array, and solving the coarse grid array and using the resulting solution to fix points in the fine grid array before it is solved, and (3) defining and solving a dynamic grid array based upon constant saturation contours.

### CROSS REFERENCE TO RELATED APPLICATIONS

This application claims priority from U.S. Provisional Patent Application 60/577,975, filed Jun. 7, 2004.

### BACKGROUND OF INVENTION

The fact that traditional, Taylor-series based, finite difference equations are inaccurate at representing reservoir pressures near the wells in petroleum reservoirs has long been known. Most simulators do not simulate wellbore pressures directly with finite difference equations, but instead correct simulated well cell pressures to obtain the actual wellbore pressures with a “well equation”. Many use an empirical productivity index, PI:

9Q=PI·(p_{well}−p_{cell}) (I-1)

In 1978, Peaceman¹ was perhaps the first to suggest a method of calculating the PI, or the difference in the well bore and well cell pressures:

$$PI = 2 π {\frac{Kh}{μ} [ ln ( \frac{0.2 Δ x}{{r}_{w}} ) ]}^{- 1} or \\ {p}_{well} - {p}_{cell} = \frac{1}{2 π} \frac{Q μ}{Kh} ln ( \frac{0.2 Δ x}{{r}_{w}} ) \qquad ( I \text{-} 2 )$$

This expression is based on the pressures in a 2-D, homogeneous, isotropic, reservoir with vertical, fully penetrating wells arranged in a five-spot pattern. The finite difference grid consists of square cells. This expression, “Peaceman's correction”, is still widely used despite errors that occur when the geometry and reservoir properties differ substantially those of his study. However, since that pioneering work, Peaceman^{2,3} and others⁴⁻⁷ have proposed alternative well equations to accommodate non-square well cells, anisotropic permeabilities, and off-center and multiple wells within a grid cell. Ding et al.⁸ proposed altered transmissibilities between the well cell and neighboring cells, as a companion to the well equation. However, none of the proposed well equations are adequate for all wells, and the growing complexity of well geometries, including horizontal wells, slant wells, and multilateral completions, makes it difficult to know which if any of the well equations is adequate.

Additionally, since the beginning of the Petroleum Industry, reservoir simulation has played an important part in the optimization of oil and gas production.¹⁻⁴ With the advent of computers, physical and analog models were replaced with faster digital, computational simulations. However, despite the enormous increases in computer speeds and memories that have occurred over the years, computers have never been fast enough or big enough to meet the ever-escalating needs of reservoir simulation. Several emerging technologies which employ reservoir simulators make the need for faster simulators and faster computers as acute as ever:

### Automatic History Matching

Simulated reservoir histories seldom exactly match actual histories. Differences usually result from inaccurate data, but sometimes they occur as the result of mathematical shortcuts. Whatever the reason, simulation engineers, even in the early years of simulation, have tried to improve their match by adjusting their data.⁵ It has been proposed that this time-intensive process be automated. The process is relatively simple when the data values to be adjusted are less than fifty and when simulations can be accomplished in a few minutes. However, the problem of matching by adjusting thousands of data values, using simulators that take hours to run, remains a very difficult task.⁶

### Geostatistics

It is never possible to have enough data to accurately describe the reservoir. Even for relatively shallow reservoirs, it is impractical to have wells drilled sufficiently close to one another that well logs can accurately determine all the variations in properties throughout the reservoir. Hence the science of geostatistics has emerged in recent years. Geostatistics involves gathering large quantities of data on out-crops, where such measurements can be made. The same statistical variations in properties are then applied to subterranean reservoirs. This approach results in not one, but many possible models of the reservoir, each with some probability of being correct.⁷ The reservoir models are generally larger than traditional simulation models in order that all probable variations can be represented. Simulation of all the geostatistical reservoir models results in not one production history, but in a most probably history, combined with the likelihood that that history is correct. Such results can be very valuable, as they provide a measure of the field's profitability as well as the risk. However, the cost is many simulations, one for each geostatistical model. This technology is practical only when simulations can be made rapidly.⁸

### Optimization

Reservoir simulations studies usually entail repeated simulations to examine the effects of well locations, completion intervals, well rates, well remedial treatments, etc. It would be ideal if the simulator could optimize the desired parameters without the intervention of the simulation engineer. Optimization theory makes such a task theoretically possible, but to be practical, again a fast simulator is required so that many repeated simulations can be made.^{9,10}

### Smart Wells

Smart wells use packers to isolate various production intervals in a well, and valves that control the amount of flow from each interval. Sophisticated smart wells not only provide infinitely variable chokes, but also monitor pressure, temperature, sand production, multi-phase flow rates, and provide resistivity and seismic sensors for tracking near well fluid contacts.¹¹ Optimal control theory is used to determine the valve settings. Yeten et al.¹² found that total production could be increased by as much as 65% using smart wells, compared with letting each interval flow unrestricted. However, this emerging technology too, requires many simulations and hence is dependent on fast simulators.

### REFERENCES FOR SECTION I

1. Peaceman, D. W., “Interpretation of Well-Block Pressures in Numerical Reservoir Simulation”, SPE Journal, pp 183-194, June, 1978; Society of Petroleum Engineers Transactions, vol. 265; paper SPE 6893 presented at the SPE-AIME 52^{nd} Annual Fall Technical Conference and Exhibition, held in Denver, Colo., Oct. 9-12, 1977.
2. Peaceman, D. W., “Interpretation of Well-Block Pressures in Numerical Reservoir Simulation With Nonsquare Grid Blocks and Anisotropic Permeability”, paper SPE 10528, SPE Journal (June 1983), 531-543.
3. Peaceman, D. W., “Interpretation of Wellblock Pressures in Numerical Reservoir Simulation Part 3-Off-Center and Multiple Wells Within a Wellblock,” SPE Reservoir Eng. (May 1990) 227-232; paper SPE 16976.
4. Abou-Kassem, J. H. and Khalid Aziz, “Analytical Well Models for Reservoir Simulation”, SPE Journal, 1985.
5. Babu, D. K., A. S. Odeh, A. J. Al-Khalifa, and R. C. McCann, “The Relation Between Wellblock and Wellbore Pressures in Numerical Simulation of Horizontal Wells”, SPE Reservoir Engineering (August 1991), 324: “Numerical Simulation of Horizontal Wells”, paper SPE 21425 presented at the SPE Middle East Oil Show, Bahrain, Nov. 16-19, 1991.
6. Shape, H. N. and A. B. Ramesh, “Development and Validation of a Modified Well Model Equations for Nonuniform Grids with Application to Horizontal Well and Coning Problems”, paper SPE 24896 presented at the SPE Annual Technical Conference and Exhibition, Washington, D.C., Oct. 4-7, 1992.
7. Chen, G., D. H. Tehrani, and J. M. Peden, “Calculation of Well Productivity in a Reservoir Simulator”, part I, paper SPE 29121 presented at the SPE Symposium on Reservoir Simulation, San Antonio, Tex., Feb. 12-15, 1995; part II, paper SPE 29932 presented at the SPE International Meeting on Petroleum Engineering, Beijing, China Nov. 14-17, 1995
8. Ding, Y., P. A. Lemonnier, Thierry Estebenet, and J-F. Magras, “Control-Volume Method for Simulation in a Well Vicinity for Arbitrary Well Configurations”, SPE Journal (March 2000), 5, 118-125; paper SPE 62169
9. Morel-Seytoux, Herbert J., “Unit Mobility Ratio Displacement Calculations of Pattern Floods in Homogeneous Medium’, SPE Journal (September 1966), 217-246, paper SPE 1359.
10. Selby, Samuel M., Editor, Standard Mathematical Tables, Student Edition, 15^{th} Edition, The Chemical Rubber Co., Cleveland, Ohio, p 370, integral 141.
11. Bois, G. Petit, Table of Indefinite Integrals, Dover Publications, New York, p 47.

### REFERENCES FOR SECTION II

1. BUNDY, B. C., HALES, H. B., A Streamline Reservoir Simulator with D Gridding; CIPC Paper 2004-303 presented at the Petroleum Society's 5^{th} Canadian International Petroleum Conference, Calgary, Alberta, Canada, Jun. 8-10, 2004.
2. WEBER, D. B., HALES, H. B., BAXTER, L. L., A New Method of Formulating Finite-difference Equations—Some Reservoir Examples; CIPC Paper 2004-170 presented at the Petroleum Society's 5^{th} Canadian International Petroleum Conference, Calgary, Alberta, Canada, Jun. 8-10, 2004.
3. GAUTIER, Y., BLUNT, M. J., CHRISTIE, M. A., Nested Gridding and Streamline-Based Simulation for Fast Reservoir Performance Prediction; Proceedings of the SPE Symposium on Reservoir Simulation, SPE 51931, pp. 403-412, February 1999.
4. PEACEMAN D. W., Fundamentals of Numerical Reservoir Simulation; Elsevier Scientific Publishing Company, New York 1977.
5. HOFFMAN, J. D., Numerical Methods for Engineers and Scientists; Second Edition, Marcel Dekker, Inc., New York, 2001.
6. ANDERSON, E., BAI, Z., BISCHOF, C., BLACKFORD, S., DEMMEL, J., DONGARRA, J., DU CROZ, J GREENBAUM, A., HAMMARLING, S., MCKENNEY, A., SORENSEN, S., LAPACK Users' Guide; Third Edition, SIAM, Philadelphia, Pa., 1999.
7. MATHWORKS, INC., MATLAB 7.0 The Language of Technical Computing; Mathworks www.mathworks.com.
8. FLANNERY, B. P., PRESS, W. H, TEUKOLSY, S. A., VETTERLING, W. T., Numerical Recipes in Fortran 77; Second Edition, Press Syndicate of the University of Cambridge, New York, 1992.

### REFERENCES FOR SECTION III

1. Buckley, S. E. and Leverett, M. C.: “Mechanisms of Fluid Displacement in Sands,” Trans., AIME (1942) 146, 107.
2. Muskat, M.: Flow of Homogeneous Fluids, Intl. Human Resources Development Corp. Boston, Mass. (1937, 1982).
3. Muskat, M.: “The Theory of Potentiometric Models,” Trans., AIME (1948) 179, 216.
4. Muskat, M. and Wyckoff, R.: “A Theoretical Analysis of Waterflooding Networks” Trans., AIME (1934) 107, 62.
5. Agarwal, B., H. Hermanson, J. E. Sylte, and L. K. Thomas, “Reservoir Characterization of Ekofisk Field: A Giant, Fractured Chalk Reservoir in the Norwegian Sea—History Match”, SPE paper 68096 presented at the SPE Reservoir Simulation Symposium, Houston, Tex., 14-17 Feb. 1999; SPEREE, December 2000, pp 534-543.
6. Kabir, C. S., M. C. H. Chien, and J. L. Landa, “Experiences With Automated History Matching”, SPE Paper 79670 presented at the SPE Reservoir Simulation Symposium, Houston, Tex., USA, 3-5 Feb. 2003.
7. Beraldo, V. T., O. A. Pedrosa Jr., and A. Z. Remacre, “Simulation of Water Coning Behavior Using Geostatistic Techniques to Represent Reservoir Heterogeneities”, SPE paper 27020 presented at the III Latin American/Caribbean Petroleum Engineering Conference, Buenos Aires, Argentina, 27-29 Apr. 1994.
8. Le Ravalec-Dupin, M. and D. H. Fenwick, “A Combined Geostatistical and Streamline-Based History Matching Procedure”, SPE paper 77378 presented at the SPE Annual Technical Conference and Exhibition, San Antonio, Tex., 29 September-2 Oct. 2002.
9. Badru, O. and C. S. Kabir, “Well Placement Optimization in Field Development”, SPE paper 84191 presented at the SPE Annual Technical Conference and Exhibition held in Denver, Colo., U.S.A., 5-8 Oct. 2003.
10. Thiele, M. R. and R. P. Batycky, “Water Injection Optimization Using a Streamline-Based Workflow”, SPE Paper 84080 presented at the SPE Annual Technical Conference and Exhibition, Denver, Colo., 5-8 Oct. 2003.
11. S. M. Erlandsen, SPE, Production Experience From Smart Wells in the Oseberg Field”, SPE Paper 62953 presented at the 2000 SPE Annual Technical Conference and Exhibition held in Dallas, Tex., 1-4 Oct. 2000.
12. Yeten, B., L. J. Durlofsky, and K. Aziz, “Optimization of Smart Well Control”, SPE Paper 79031 presented at the SPE International Thermal Operations and Heavy Oil Symposium and International Horizontal Well Technology Conference, Calgary, Canada, 4-7 Nov. 2002.
13. Weber, D. B., H. B. Hales, and L. L. Baxter, “A New Method of Formulating Finite Difference Equations—Some Reservoir Simulation Examples”, CIPC Paper 2004-170 presented at the Petroleum Society's 5^{th} Canadian International Petroleum Conference, Calgary, Alberta, Canada, Jun. 8-10, 2004
14. Glimm, J., B. Lindqist, O. McBryan, and L. Padmanabhan. “A Front Tracking Reservoir Simulator, Five-Spot Validation Studies and the Water Coning Problem,” The Mathematics of Reservoir Simulation, R. Ewing (ed.), SIAM, Philadelphia (1983) 107-36.
15. Hales, H. B., “A Reservoir Simulator Based on the Method of Characteristics”, SPE Paper 13219 presented at the SPE 59^{th} Annual Technical Conference and Exhibition, Houston, Tex., 16-19 Sep. 1984.
16. Bratvedt, F., K. Bratvedt, C. F. Buchholz, L. Holden, H. Holden, and N. H. Riesbro, “A New Front-Tracking Method for Reservoir Simulation”, SPE Paper 19805, SPERE, February, 1992, pp 1076-116.
17. Batycky, R. P., Blunt, M. J., and Thiele, M. R.: “A 3D Field-Scale Streamline-Based Reservoir Simulator,” SPERE (November 1997) 246.
18. Bratvedt, F., Gimse, T., and Tegnander, C.: “Streamline Computations for Porous Media Flow Including Gravity, Transport in Porous Media, (October 1996) 25, No. 1, 63.
19. Han, D. K., D. L. Han, C. Z. Yan, and L. T. Peng, “A More Flexible Approach of Dynamic Local Grid Refinement for Reservoir Modeling”, SPE paper 16014 presented at Ninth SPE symposium on Reservoir Simulation, San Antonio, Tex., 1-4 Feb. 1987.
20. Datta-Gupta, A., “Streamline Simulation: A Technology Update”, Journal of Petroleum Technology, December 2000, pp 68-73.

### SUMMARY OF INVENTION

The present invention is an improvement over prior-art methods for simulating pressures and saturations of oil, gas and water in an oil reservoir. Typically the oil reservoir will have one or more of a production and/or injection well. In a typical prior-art method, the reservoir is divided into a large array of grid blocks, with permeability and porosity defined for each block. An approximating set of linear algebraic equations is generated to represent the partial differential equations governing flow in the reservoir. These are generally referred to as finite difference equations, with one equation for each block. Usually the finite difference approximations are derived from the partial differential equations using Taylor Series, which assumes that the pressures can be represented by polynomials.

The set of linear equations is then solved by a simultaneous solution method. Many algorithms (solvers) are available, but in this application iterative methods are generally used because they are most efficient for large systems of equations. The finite difference equations corresponding to each partial differential equation are generally solved simultaneously. However, multigrid methods solve successively for varying grid sizes to eventually find the solution of the finest grid.

The present invention involves improved methods for the simulation of reservoirs that are discussed in detail in Sections I, II, and III.

### Weber Method

The method in Section I, also called the Weber method, involves a new method for formulating finite differential equations. It is also disclosed in Reference 2 of the Section II citations. The Weber finite difference equations more accurately represent actual pressures and are better able to account for the growing complexity of well geometries.

Finite difference approximations to partial derivatives are generally based on Taylor series, which are polynomial expressions for the unknown variable as a function of the grid locations. In many problems, approximate analytical solutions are known that incorporate the physics of the process. It is proposed that such expressions be used to derive finite difference equations. Increased accuracy is anticipated, particularly when the solutions are highly non-linear, singular, or discontinuous.

Reservoir simulation is such a problem. Flow in petroleum reservoirs results from injection and productions from wells, which are relatively small sources and sinks. Near singularities in the pressure around the wells result. The immiscibility of the fluids causes an oil bank to form in front of displacing water, and near discontinuities in the saturations occur. The invention involves the use of finite difference equations for reservoir pressures based on two new functional forms: ln(r) and 1/r, where r is the distance to the well. The ln(r) form is based on pressures from line sources, and thus is effective at representing straight line wells. The 1/r form is based on pressures from point sources. The sum of many points represent more complex wells. Both are found to greatly increase the accuracy of the simulated reservoir pressures relative to solutions based on the polynomial approach. The new system of approximating linear equations is based on these upon finite difference equations that include ln(r) or 1/r, where r is the distance from a well bore.

In an implementation of the Weber method, the pressures are assumed to be logarithmic in from rather than polynomial. The resulting finite difference approximation to the first order partial derivative is:

$$\frac{\partial p}{\partial x} = - \frac{( {p}_{i + 1} - {p}_{i} ) \sum \frac{Q x}{{r}^{2}}}{\sum Q ln ( {r}_{i + 1} ) - \sum Q ln ( {r}_{i} )}$$

The resulting finite difference equations for the reservoir pressures are identical to traditional, polynomial based equations, except that cell permeabilities, K, must be multiplied by an expression, forming a pseudo-permeability:

$${K}_{x +}^{′} = {K}_{x +} \frac{\sum Q {α}_{x +}}{\sum Q ln ( {r}_{i + 1} ) - \sum Q ln ( {r}_{i} )}$$

where α is the angle in radians swept by the cell face relative to the well. These logarithmic-based finite difference equations work well for wells that pass through the reservoir in a straight line perpendicular to the reservoir layers.

In another implementation of the Weber method the pressures are assumed to be inverse-r in form resulting from a number of point sources, rather than a polynomial. A resulting finite difference approximation to the first order partial derivative is:

$$\frac{\partial p}{\partial x} = \frac{( {p}_{i + 1} - {p}_{i} ) \sum \frac{Qx}{{r}^{3}}}{\sum \frac{Q}{{r}_{i + 1}} - \sum \frac{Q}{{r}_{i}}}$$

The resulting finite difference equations for the reservoir pressures are identical to traditional, polynomial based equations, except that cell permeabilities, K, must be multiplied by an expression, forming a pseudo permeability, K′:

$${K}_{x +}^{′} = {K}_{x +} \frac{\sum Q {Ω}_{x +}}{\sum \frac{Q}{{r}_{i + 1}} - \sum \frac{Q}{{r}_{i}}}$$

where Ω is the solid angle in sterradians swept by the cell face relative to the well. These logarithmic-based finite difference equations work well for wells that are completed through a few perforations. The above equations can be integrated over wells regions of any geometry. The resulting integral equations work well for the most complex of well geometries.

In another implementation of the Weber method the coefficients of the finite difference equations for cells in the immediate vicinity of the wells are calculated by the Weber method. The equations for the remaining cells are calculated by finite difference equations based upon polynomials derived from Taylor Series.

### Hardy Method

The method described in Section II, also referred to as the Hardy method, is a new method for the determination of finely gridded reservoir simulation pressures. It is estimated to be as much as tens to hundreds of times faster than prior-art methods for very large reservoir simulation grids. The method can be used in conjunction with methods that uses iterative algorithms to solve the approximating linear equations. In a preferred implementation, it is used with the Weber system of Section I. In the Weber system, accuracies normally requiring millions of cells using traditional finite-difference equations, using only hundreds of cells. This was accomplished through the use of finite-difference equations that incorporate the physics of the flow. Although these coarse-grid solutions achieve accuracies normally requiring orders of magnitude more resolution, their coarse resolution does not resolve local pressure variations resulting from fine-grid permeability variations.

The Hardy method is for obtaining the full, fine-grid solution with significantly reduced computer times by incorporating the accurate course-grid solution. The method involves two steps: (1) using a set suitable approximating linear equations (e.g. Weber's equations or Taylor-Series equations) to obtain an accurate pressure solution on a coarse grid, and (2) refining the grid to obtain detailed pressures that honor the course-grid pressures. The performance of various linear algebraic solvers is considered to maximize the speed of calculations of both the coarse and fine grid steps.

In the Hardy method, the set of approximating linear algebraic equations is solved by defining a coarse grid with substantially fewer cells than the fine grid. The fine grid is the same as that defined for prior-art method or the Weber methods described above. The coarse grid is defined so that the fine grid is nested within the coarse grid with cell centers of the coarse grid corresponding to cell centers of the fine grid. The course grid's pressures could potentially be calculated by any linear algebra solution algorithm. Since the number of unknowns for coarse grid is significantly smaller than for the fine grid the computation of its solution is simpler and faster. Weber's method is also preferred for the coarse grid, as the final solution will only have the accuracy of the coarse grid. However, it is contemplated that the Hardy method could be used with other finite difference equation formulations, as well as any suitable iterative or non-iterative solution method.

After the coarse grid is solved, the value of each corresponding fine grid point corresponding to a solved coarse grid point is fixed in the fine grid system. The remaining unknown fine grid pressures are then solved such that the embedded course grid pressures are honored.

The iterative method used to solve the approximating linear equations for the coarse grid and those for the fine grid may be the same or different. Comparison of many current linear algebra solvers suggested that successive over-relaxation is the best methods for the solution of both grids. In general, the fastest linear algebra algorithms is preferred, but it is contemplated that any suitable algorithm be used in the invention. Since the coarse grid is smaller it may also be practical in some circumstances to use a non-iterative method.

### Bundy Method

In the method described in Section III, also know as the Bundy method, the use of any of the previous methods in combination with streamline simulation and dynamic griding vastly improve the prediction of reservoir saturations in modern simulation.

In addition to the use of Weber equations to improve the prediction of reservoir pressures, another improvement to the field is described herewith. In Section III, an exemplary implementation of a reservoir simulator is described that combines certain simulation technologies herein described to create a simulator of increased speed, accuracy, and versatility. These new technologies include:

### Finite Difference Equations for Reservoir Pressures

This is described in the background Section I and is to allow determination of reservoir pressures. Preferably the Weber method is used, because this method incorporates the sharp pressure gradients that occur around the wells.

### Streamline Simulation for Reservoir Saturations

The reservoir pressures are used to determine the velocity of reservoir fluids and the location of the resulting streamlines. Saturations are then determined by 1-D solutions along each streamline.

### Dynamic Gridding

The saturations on each streamline are determined by solving 1-D finite difference approximations to the saturation equation. However, the locations of specific saturation values are determined rather than the usual determination of saturations at specific locations. The resulting dynamic spatial grid is finely spaced in areas where saturations are changing most rapidly.

The resulting method using all three these features rigorously accounts for gravity, capillary pressures, and all other phenomena that can be incorporated into traditional, non-streamline, finite difference equations (particularly when used together with the Weber method). The results of a 2-D, 2-well, waterflood simulation in the exemplary implementation in Section III below illustrate the substantial detail and understanding that can be gained from a relatively coarsely gridded simulation. While the Weber method for producing the finite difference equations is preferred it is contemplated that the Bundy method also be used in conjunction with any suitable system for producing the finite difference equations.

In the Bundy method the grid is constructed with the points (cell centers) positioned on constant saturation contours, i.e., at predetermined values of saturation, rather that at predetermined coordinates. The saturation contours are at predetermined intervals. The algorithm consists of the following steps
determining of the reservoir pressures using traditional methods or the improved methods of the Weber,
locating the bulkflow streamlines based on the previously calculated pressures. This can be done either by Euler's Method which involves for each point calculating the velocity and taking a timestep in that direction, stepping across the reservoir from the injection wells to the production wells, or by higher order methods such as Runge Kutta.
calculating the position on the streamline were the streamline intersects a constant saturation contour (line in 2d surface in 3d), and a time (τₙ₋₁), associated with the intersection, where the time (τₙ₋₁) is the travel time within the reservoir from the position of the point to the intersection position (τ=0 first time)
moving or displacing the grid point to a position along the streamline to a new time location (moving all the grid points also moves the constant saturation contour) by calculating a new time (τₙ) consistent with the relationship,

$${\int }_{{τ}_{n - 1}}^{{τ}_{n}} Δ S d τ = - Δ f \cdot Δ t ;$$

recalculating the pressures for the new grid and repeating the above steps.

In an exemplary implementation of the Bundy the new time new time (τₙ) is calculated using the approximate equation:

$${τ}_{n} = {τ}_{n - 1} - \frac{1}{{S}_{n} - {S}_{mf + 1}} [ \begin{matrix}Δ f \cdot Δ t + ( {S}_{n - 1} - {S}_{m} ) ( {τ}_{m s} - {τ}_{n - 1} ) + \\ {\sum }_{m = m s}^{mf} ( {S}_{m} - {S}_{m - 1} ) ( {τ}_{m} - {τ}_{m - 1} )\end{matrix} ]$$

The Bundy system is adaptable to two-dimensional or three-dimensional simulation. As noted above, the pressures for the grid are calculated using any suitable method, but the Weber method is preferred. The Bundy system can also be incorporated with the Hardy system by creating a coarse grid with fewer constant saturation contours and with fewer grid points on each contour.

### BRIEF DESCRIPTION OF DRAWINGS

FIG. 1 is a 2-dimensional hypothetical reservoir grid.

FIG. 2 is a reservoir pressure error summary for the grid in FIG. 1.

FIG. 3 is a 3-dimensional hypothetical reservoir grid.

FIG. 4 is a reservoir pressure error summary for the grid in FIG. 3.

FIG. 5 is a schematic of an exemplary hypothetical reservoir.

FIG. 6 is a graph showing time required for convergence as a function of grid size.

FIG. 7 is graph showing memory (RAM) requirements as a function of grid sized for direct methods.

FIG. 8 is a graph showing time required for convergence as a function of grid size for iterative methods.

FIG. 9 is a graph showing memory requirements as a function of grid size for iterative methods.

FIG. 10 is a graph showing improvement obtained by nested grid method.

FIG. 11 is a graph showing the number of coarse grid point versus the number of fine or total grid points.

FIG. 12 is a graph showing a comparison of improvement of nested grid method with GMRES.

FIG. 13 is a comparison of dynamic grid results and static grid results with the analytical (Buckley-Leverett) solution.

FIG. 14 is the equations and corresponding graphs of the relative permeability functions.

FIG. 15 is a Dynamic Grid Solution after the first timestep.

FIG. 16 is the Dynamic Grid Solution after twenty timesteps.

FIG. 17 is the Dynamic Grid Solution at breakthrough, thirty-four timesteps.

FIG. 18 is the Dynamic Grid Solution after breakthrough, sixty timesteps.

### DETAILED DESCRIPTION

### Section I. Method of Formulating Finite Difference Equations

An aspect of the present invention involves the use of finite difference equations that incorporate the singularities in pressure at the wells. The Weber finite difference equations accurately represent the actual pressures at the wellbore and elsewhere in the well cells. No well equations are required. The Weber method hypothesizes that traditional finite difference equations are unable to predict wellbore pressures because they are based on Taylor series, which are polynomial in form. Polynomials are continuous functions and are unable to represent singularities. Instead of polynomials, finite difference equations are derived on 1) ln(r)-functions and 2) 1/r functions, both of which are singular as r approaches zero.

Finite Difference Equations Based on Logarithmic Functions

In an infinite, homogeneous reservoir with steady-state flow, the flow velocity, q, from an infinite straight line source in the reservoir, dissipates inversely as the cylindrical area around the line: q=Q/2πr, where Q is the total flow rate per unit length. If Darcy's Law

$$q = - \frac{K}{μ} \frac{d p}{d r} ,$$

is incorporated, the equation can be integrated to obtain:

$$p = \frac{Q μ}{2 π K} ln ( r ) + c .$$

For many simultaneous line sources, superposition requires that the steady state pressure in an infinite, homogeneous, isotropic reservoir, is given by

$$p = \frac{μ}{2 π K} {\sum }_{n}^{\begin{matrix}all \\ wells\end{matrix}} {Q}_{n} ln ( {r}_{n} ) + c \qquad ( I \text{-} 3 )$$

here rₙ is the least distance to well n, i.e. the perpendicular distance.

This fundamental expression suggests that finite difference equations which are based on expressions incorporating a ΣQln(r)-term may result in solutions which accurately incorporate the singularity in pressures around the wells. There are many such expressions that might be used. Most, however, do not result in pressure equations which conserve mass. Perhaps the simplest conservative expression is

$$p = a {\sum }_{n}^{\begin{matrix}all \\ wells\end{matrix}} {Q}_{n} ln ( {r}_{n} ) + c \qquad ( I \text{-} 4 )$$

If we use this equation to find p at grid points i and i+1, the two equations can men be combined to eliminate c, and solved for α:

$$a = \frac{{p}_{i + 1} - {p}_{i}}{{\sum }_{n} {Q}_{n} ln ( {r}_{n , i + 1} ) - {\sum }_{n} {Q}_{n} ln ( {r}_{n , i} )} \qquad ( I \text{-} 5 )$$

Differentiating equation (4) and substituting (5) for α, results in a finite difference expression for the derivative:

$$\frac{\partial p}{\partial x} = - \frac{( {p}_{i + 1} - {p}_{i} ) \sum \frac{Qx}{{r}^{2}}}{\sum Q ln ( {r}_{i + 1} ) - \sum Q ln ( {r}_{i} )} \qquad ( I \text{-} 6 )$$

where Σ still represents the sum of all the wells.

Traditional, Taylor-series based, finite difference equations for reservoir simulation approximate this derivative with

$$\frac{\partial p}{\partial x} = \frac{{p}_{i + 1} - {p}_{i}}{{x}_{i + 1} - {x}_{i}} \qquad ( I \text{-} 7 )$$

Darcy Law fluxes are given by qₓ=−(Kₓ/u)(∂p/∂x). Hence the new, ln-r, finite difference equations can be incorporated into existing reservoir simulators simply by using pseudo-permeabilities:

$${K}_{x}^{′} = {K}_{x} \frac{( {x}_{i + 1} - {x}_{i} ) \sum \frac{Qx}{{r}^{2}}}{\sum Q ln ( {r}_{i + 1} ) - \sum Q ln ( {r}_{i} )} \qquad ( I \text{-} 8 )$$

Note however, that these pseudo-perms must be updated each time the well rates change relative to one another. Equations for K′_{y} and K′_{z} derived similarly and are analogous.

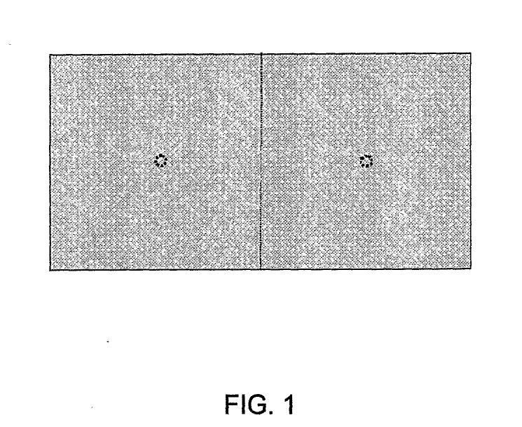

The ln-r based finite difference equations were evaluated by examining the pressures in the 2-D, homogeneous, isotropic rectangular reservoir illustrated in FIG. 1. The reservoir consisted of two adjacent squares, comprising a 900×1800 foot rectangle. A six-inch diameter injection well was centered in one square, and a six-inch production well in the other. An 9×18 finite difference grid was used, making the grid spacing 100 ft. The pressure in the injection well was 1000 psi; in the production well, −1000 psi.

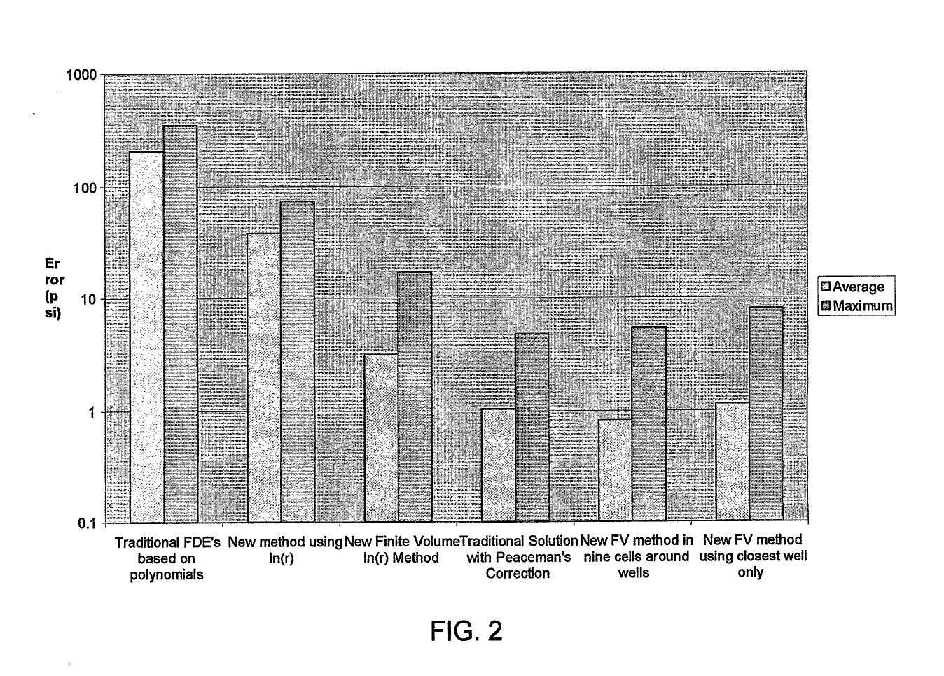

The error in the solution was determined by comparing the ln-r results at each grid point with the analytical solution of Morel-Seytoux⁹. The results are shown in FIG. 2. The figure compares the average of the absolute values of the errors, and the maximum error of all the cells, for several solution methods. The first pair of bars shows the errors using traditional finite difference methods based on polynomials, and assumes that the wellbore pressure is the same as the well cell pressure. The second set of bars shows the results for the ln-r solution described above. Errors from the ln-r solution are reduced by a factor of about five. This is a substantial reduction, but not compared with the results using Peaceman's correction method shown in the fourth set of bars, in which the average pressure error is reduced by a factor of 200. Peaceman's method is ideally suited to this problem.

FDE's Based on a Finite Volume Analysis using the In-r Functions.

The new ln-r approach, described above, assumes that the fluxes through a cell's sides are the same everywhere on the side, and that everywhere they have value at the center of the side, i.e. at the point midway between grid points.

A more accurate solution, one more comparable to Peaceman's, might be achieved with a volumetric approach in which the flux varies over the cells' edge as prescribed by Equation 1-4.

Using Darcy's law and Equation 1-4, the total flux through the x-faces of a cell (i.e. faces oriented such that x is constant) is given by:

$${Q}_{x} = - \frac{{K}_{x} h}{μ} \int \frac{d p}{d x} d y = a \frac{{K}_{x} h}{μ} \sum Q {\int }_{{y}_{j} - \frac{Δ x}{2}}^{{y}_{j} + \frac{Δ x}{2}} \frac{x d y}{{x}^{2} + {y}^{2}} \qquad ( I \text{-} 9 )$$

The last integral in the above equation is, in fact, the acute angle, αₓ, that the x-face's endpoints make with the well. αₓ has the same sign as x. It can be evaluated as:

$${α}_{x} = sign ( x ) \vert {tan}^{- 1} [ \frac{( y + Δ x / 2 )}{x} ] - {tan}^{- 1} [ \frac{( y - Δ x / 2 )}{x} ] \vert \qquad ( I \text{-} 10 )$$

Analogous formulae can be derived for the angles subtended by the other faces.

Substituting α with Equation 5 into Equation 9 gives the total flux through the cell's x-face to the right of the cell center:

$${Q}_{x +} = - \frac{{K}_{x +}}{μ} \frac{( {p}_{i + 1} - {p}_{i} ) \sum Q {α}_{x +}}{\sum Q ln ( {r}_{i + 1} ) - \sum Q ln ( {r}_{i} )} \qquad ( I \text{-} 11 )$$

This equation is identical to the usual finite difference formulation for the flux except that the permeability K is replaced by K′ where

$${K}_{x +}^{′} = {K}_{x +} \frac{\sum Q {α}_{x +}}{\sum Q ln ( {r}_{i + 1} ) - \sum Q ln ( {r}_{i} )} \qquad ( I \text{-} 12 )$$

Analogous equations can be derived for the y and z directions.

The finite difference equations describing the reservoir pressure were solved with the modified permeabilities from the above Equation I-12. The pressures were determined for the same 3-D, homogeneous, isotropic rectangular reservoir used previously and illustrated in FIG. 1. The results are included as the third set of bars in FIG. 2. The average pressure error is reduced by a factor of 12 compared with the previous ln-r solution, and by a factor of 66 relative to the traditional solution, but still remains somewhat greater than Peaceman's solution.

The other two solutions, the traditional one based on polynomials and the one based on ln-r, each exhibited maximum pressure errors in cells adjacent to the well cell. The Finite Volume ln-r solution of Equation I-12, however exhibits a maximum error on the reservoir boundary. This fact suggests that the ln-r solution does a good job of representing the pressure singularity at the wells, but a poor job of representing the boundary conditions, dp/dx=0 and dp/dy=0. Solutions were attempted in which traditional equations were used near the boundary and ln-r equations were used near the wells. Additional reductions in the error were observed, making this hybrid method of comparable accuracy to Peaceman's method. It seems to make little difference how many cells near the boundary use the traditional method and how many cells near the wells used the ln-r method, so long as cells on the boundary are traditional, and the nine cells comprising a 3×3 block around the wells are ln-r. The fifth bar pair in FIG. 2 shows the results obtained using the ln-r solution in only the nine cells around each well. Actually, the pseudo linking permeabilities of Equation I-12 were used everywhere in the nine cells, and to conserve mass, the same pseudo linking permeabilities were used for flow into the adjacent twelve cells, from the nine. The average pressure error was 255 times less than the traditional solution and twenty percent better than Peaceman's solution.

The success of the nine-cell ln-r solution patch in a traditional solution shows that the solution can be corrected locally. It suggested that distant wells need not be included either, and that a basis function analogous to Equation I-4 but with only one well, might be useful:

p=αQln(r)+c (I-13)

where Q and r are the rate and distance to the nearest well, respectively. This equation results in pseudo permeabilities, analogous to Equation I-12, which are given by:

$${K}_{x +}^{′} = {K}_{x +} \frac{{α}_{x +}}{ln ( {r}_{i + 1} / {r}_{i} )} \qquad ( I \text{-} 14 )$$

Results of a simulation using these pseudo-permeabilities in nine cell-patches around the wells are shown as the last bar pairs, the sixth set, of FIG. 2. There is some loss in accuracy, about 30% relative to the nine-cell solution containing all the wells, the fifth set of bars. However, the loss in accuracy may be justified by the simplicity of Equation I-14, particularly when large numbers of wells are encountered and well rates change frequently.

It is interesting to note that when Equation I-14 is applied only to the cells containing wells, and the wells are centered in the cells, the following equation can be derived:

$${p}_{well} - {p}_{cell} = \frac{1}{2 π} \frac{Q μ}{Kh} ln ( \frac{c Δ x}{{r}_{w}} ) \qquad ( I \text{-} 15 )$$

where c=e^{-π/2}=0.20788. This equation is similar to Peaceman's correction¹ of Equation I-2 and appears in that reference as an “approximation”.

Finite Difference Equations Based on Inverse-r Functions.

In an infinite, homogeneous reservoir with steady-state flow, the flow velocity, q, from a point source in the reservoir, dissipates inversely as the spherical area around the point: q=Q/4πr², where Q is the total flow rate. If Darcy's Law,

$$q = - \frac{K}{μ} \frac{d p}{d r} ,$$

is incorporated, the equation can be integrated to obtain:

$$p = \frac{Q μ}{4 π K} \frac{1}{r} + c .$$

For many, simultaneous point sources, superposition requires that the steady state pressure in an infinite, homogeneous, isotropic reservoir, is given by

$$p = \frac{μ}{4 π K} {\sum }_{n}^{\begin{matrix}all \\ points\end{matrix}} \frac{{Q}_{n}}{{r}_{n}} + c \qquad ( I \text{-} 16 )$$

This fundamental expression suggests that finite difference equations which are based on expressions incorporating a ΣQ/r-term may result in solutions which accurately incorporate the singularity in pressures around the wells. There are many such expressions that might be used. Most, however, do not result in pressure equations which conserve mass. Perhaps the simplest conservative expression is

$$p = a {\sum }_{n}^{\begin{matrix}all \\ points\end{matrix}} \frac{{Q}_{n}}{{r}_{n}} + c \qquad ( I \text{-} 17 )$$

In the traditional way of deriving finite difference equations, we can solve for a in terms of pᵢ and pᵢ₊₁:

$$a = \frac{{p}_{i + 1} - {p}_{i}}{{\sum }_{n} \frac{{Q}_{n}}{{r}_{n , i + 1}} - {\sum }_{n} \frac{{Q}_{n}}{{r}_{n , i}}} \qquad ( I \text{-} 18 )$$

where subscripts i and i+1 indicate values at x and x+Δx, respectively. Differentiating Equation I-16 and substituting 17, results in the finite difference expression:

$$\frac{\partial p}{\partial x} = - \frac{( {p}_{i + 1} - {p}_{i} ) \sum \frac{Qx}{{r}^{3}}}{\sum \frac{Q}{{r}_{i + 1}} - \sum \frac{Q}{{r}_{i}}} \qquad ( I \text{-} 19 )$$

where Σ still represents the sum of all point sources.

Traditional finite difference equations for reservoir simulation are written with Darcy's Law fluxes, qₓ=−(Kₓ/μ)(∂p/∂x), approximated with

$${q}_{x} = - \frac{{K}_{x}}{μ} \frac{{p}_{i + 1} - {p}_{i}}{{x}_{i + 1} - {x}_{i}} \qquad ( I \text{-} 20 )$$

Hence the new, inverse-r, finite difference equations can be simulated in existing reservoir simulators simply by changing the permeabilities:

$${K}_{x}^{′} = {K}_{x} \frac{( {x}_{i + 1} - {x}_{i} ) \sum \frac{Qx}{{r}^{3}}}{\sum \frac{Q}{{r}_{i + 1}} - \sum \frac{Q}{{r}_{i}}} \qquad ( I \text{-} 21 )$$

Equations for the y and z directions are derived similarly and are analogous.

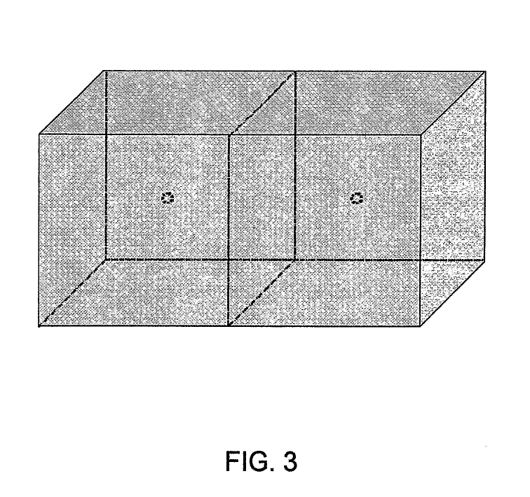

The inverse-r finite difference equations were evaluated by examining the pressures in a 3-D, homogeneous, isotropic, rectangular reservoir illustrated in FIG. 3. The reservoir consists of two adjacent cubes, with side lengths of 1100 ft. A six-inch diameter, spherical source (injector) was centered in one cube, and a six-inch spherical sink (producer) in the other. An 11×11×11 finite difference grid was used, making the grid spacing 100 ft. The pressure of the injector was 1500 psi, and the producer −1500 psi.

The “exact” solution was determined by superimposing the pressures resulting from wells located in mirror image positions across the reservoir boundaries. The pressures predicted by Equation I-16 were used. A very large number of wells were required to make the reservoir pressures converge. The wells were arranged in a cubic lattice surrounding the reservoir with alternating y-z planes of producers and injectors. The absolute flow rates in each of the wells were the same, but positive for the producers, negative for the injectors. A 3-D lattice, containing more than a billion wells was used to obtain the necessary accuracy. The “exact” pressure was calculated in this manner for each of the 11³ (=1331) finite difference grid points in the reservoir.

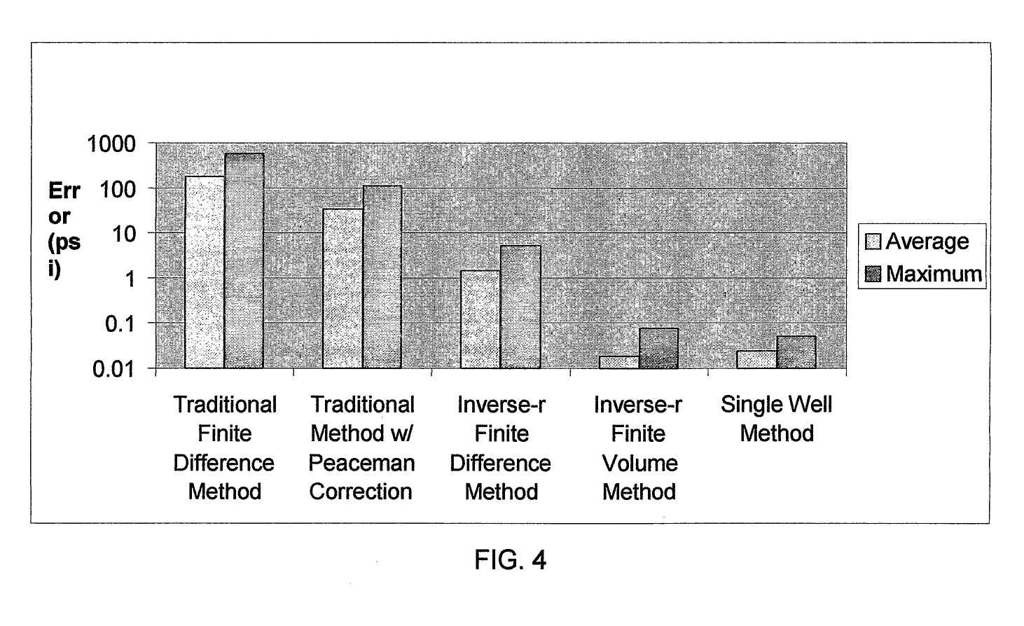

The exact pressures were compared with the inverse-r solution at each grid point to determine the error. The sum of the absolute value of these errors is shown in FIG. 4, as well as the maximum error. The first pair of bars in the FIG. 4 shows the errors calculated in the same manner for traditional finite differences, i.e. where actual K's are used throughout the reservoir rather than the (K′)'s of Equation I-21. The second pair of bars shows the errors for the traditional finite difference method with Peaceman's well cell correction of Equation I-2. The third pair of bars is the 1/r solution described above. The average error from the new 1/r solution is 130 times more accurate than the traditional solution and 24 times more accurate than Peaceman's solution. Peaceman does not do such a good job in this geometry.

FDE's Based on a Finite Volume Analysis using the Inverse-r Functions.

The new finite difference method based on the simple inverse-r function of Equation I-16 results in reductions in the error by more than two orders of magnitude, compared with conventional finite difference methods. However, this approach assumes that the flux through a cell side is the same everywhere on that side and that's the value is that calculated at the center of the side, i.e. midway between grid points.

An even more accurate answer may be possible with a volumetric approach in which the flux varies over the edge of the cell as prescribed by Equation I-17.

Using Darcy's law and Equation I-17, the total flux through the x-faces of a cell (i.e. faces oriented such that x is constant) is given by:

$$\begin{matrix}{Q}_{x} = - \frac{{K}_{x}}{μ} \int \frac{d p}{d x} d A \\ = a \frac{{K}_{x}}{μ} {\int }_{{y}_{j} - \frac{Δ y}{2}}^{{y}_{j} + \frac{Δ y}{2}} {\int }_{{z}_{k} - \frac{Δ z}{2}}^{{z}_{k} + \frac{Δ z}{2}} \frac{x d z d y}{\sqrt{{( {x}^{2} + {y}^{2} + {z}^{2} )}^{3}}}\end{matrix} \qquad ( I \text{-} 22 )$$

The double integral is, in fact, the solid angle, Q, subtended by the cell side on a sphere centered at the origin. The double integration results in ^{10,11}

$${Ω}_{x} = {tan}^{- 1} [ \frac{( z + \frac{Δ z}{2} ) ( y + \frac{Δ y}{2} )}{x \sqrt{{x}^{2} + {( y + \frac{Δ y}{2} )}^{2} + {( z + \frac{Δ z}{2} )}^{2}}} ] - {tan}^{- 1} [ \frac{( z - \frac{Δ z}{2} ) ( y + \frac{Δ y}{2} )}{x \sqrt{{x}^{2} + {( y + \frac{Δ y}{2} )}^{2} + {( z + \frac{Δ z}{2} )}^{2}}} ] - {tan}^{- 1} [ \frac{( z + \frac{Δ z}{2} ) ( y - \frac{Δ y}{2} )}{x \sqrt{{x}^{2} + {( y - \frac{Δ y}{2} )}^{2} + {( z + \frac{Δ z}{2} )}^{2}}} ] + {tan}^{- 1} [ \frac{( z + \frac{Δ z}{2} ) ( y - \frac{Δ y}{2} )}{x \sqrt{{x}^{2} + {( y - \frac{Δ y}{2} )}^{2} + {( z - \frac{Δ z}{2} )}^{2}}} ] \qquad ( I \text{-} 23 )$$

Analogous formulae can be derived for the solid angles subtended by the other faces. Evaluating a with equation (I-18), the total flux through the cell's x-face to the right of the cell center becomes

$${Q}_{x +} = \frac{{K}_{x +}}{μ} \frac{( {p}_{i + 1} - {p}_{i} ) \sum Q {Ω}_{x +}}{\sum \frac{Q}{{r}_{i + 1}} - \sum \frac{Q}{{r}_{i}}} \qquad ( I \text{-} 24 )$$

This equation is identical to the usual finite difference formulation for the flux except that the permeability K is replaced by K′ where

$${K}_{x +}^{′} = {K}_{x +} \frac{\sum Q {Ω}_{x +}}{\sum \frac{Q}{{r}_{i + 1}} - \sum \frac{Q}{{r}_{i}}} \qquad ( II \text{-} 25 )$$

Analogous equations can be derived for the y and z directions.

The finite difference equations governing the reservoir pressure were solved with the modified permeabilities of Equation I-25, based on the finite volume analysis of the inverse-r function. The pressures were determined for the same 3-D, homogeneous, isotropic rectangular reservoir used previously and illustrated in FIG. 3. The results are included as the fourth bar pair in FIG. 4. Pressure errors from the finite volume formulation are reduced 78 times relative to the inverse-r finite difference formulation, and 10,071 times relative to the traditional, polynomial based, finite difference formulation.

The use of the new finite difference equations only locally around the wells, which was found successful for the ln(r) solution previously, was also considered for the inverse-r formulation. Neglecting distant wells, a basis function analogous to Equation I-17 might be:

$$p = a \frac{Q}{r} + c \qquad ( II \text{-} 26 )$$

where Q and r are the rate and distance to the nearest well, respectively. This equation results in pseudo-permeabilities, analogous to Equation 24, which are given by:

$${K}_{x +}^{′} = {K}_{x +} \frac{Q {Ω}_{x +}}{\frac{Q}{{r}_{i + 1}} - \frac{Q}{{r}_{i}}} = \frac{{Ω}_{x +} {r}_{i} {r}_{i + 1}}{{r}_{i} - {r}_{i - 1}} \qquad ( I \text{-} 27 )$$

Results of a simulation applying this simplified solution to the same homogenous, isotropic rectangular reservoir used previously are summarized as the last pair of bars, the fifth set, in FIG. 4. Average pressure error does increase slightly, about 31% relative to the multiple well finite volume solution, the fourth set of bars. However the maximum error is actually reduced. This form of the new 1/r-based finite difference equations may be preferable simply because of the simplicity of Equation I-27, particularly when large numbers of wells are encountered and when well rates vary.

Thus, finite difference equations that incorporate the physics of the problem can significantly increase the accuracy of the solution. This is particularly true for solutions which are highly nonlinear or exhibit singularities and discontinuities. For reservoir simulation FDE's which incorporate ln(r) terms, where r is the distance from the wells, are effective for straight line wells. More complex well geometries can be accommodated with FDE's containing 1/r terms.

### Nomenclature for Equations in Section I:

a=proportionality constant

c=constants of integration

h=reservoir thickness

K=permeability

K=pseudo-permeability

p=pressure

PI=productivity index of well, q/(p_{well}-p_{cell})-ratio.

q=flux or velocity of fluid through porous media.

Q=well rate; for infinitely long well (2-D well), well rate per unit length

r=radial distance from well center

r_{w}=well radius

sign(x)=mathematical operator: 1 if x>0, 0 if x=0, −1 if x<0.

x, y, z=Cartesian coordinate distances

### Greek

α=angle subtended by cell face with respect to well
Δx=grid spacing distance
μ=fluid viscosity
Σ=Sum for all wells

### Subscripts

cell=pertaining to the finite difference

i=grid point index number

n=well index number

well=pertaining to the well

x=pertaining to the x-direction cell face, i.e. the face of constant x-value

x,y,z=pertaining to the x-, y-, and z-directions, respectively

+=pertaining to the right side of the grid cell

### Section II Rapid Calculation of Finely Gridded Reservoir Simulation Pressures (Hardy Method)

### Introduction

Throughout the history of computers, reservoir simulators have always taxed the very fastest machines. Despite the tremendous increases in computer speeds in the past decades, the need for faster reservoir simulation remains as critical today as it has ever been. This need results from emerging technologies such as:
Geo-statistics, which results in many very detailed models of the same field,
Automatic history matching, which requires many simulations of the same field to determine a data set that matches the production history of the field,
Optimization, which uses repeated simulations to automatically determine the best well location, geometry, completion intervals, and rates.
Smart wells, which use real-time simulations to control the production rate from various well segments.¹

In this section is described a new linear algebra technique for the solving of finely gridded reservoir pressures. The new Hardy method can be used together with any method using finite difference equations, but is preferably used with the method of Weber et al.². Weber et al. proposed that finite-difference equations, used to represent the pressure equation, be based on mathematical expressions that incorporate the physics of the process instead of on traditional polynomial expressions. In modeling the reservoir pressures, equations incorporating the physically realistic ln(r) dependence on pressure for reservoirs with straight line wells, and a 1/r dependence for reservoirs with more complex well geometries were used (r is the distance to the well). The results of Weber's I/r based finite-difference equations are shown in FIG. 4. The figure compares the accuracy of the pressures calculated by various methods for an 11×11×22 grid of a rectangular reservoir of the same geometry used in this study. The Weber finite-difference equations showed a four-order-of-magnitude improvement in accuracy compared with traditional equations.

In the present method, the results of a finite difference method, such as Weber's method, is used to create a nested-grid method that uses both a coarse and fine grid to obtain a full, fine-grid solution with significantly reduced computer times. The method involves two steps: (1) The creation of a course-grid solution using finite-difference equations (preferably Weber's) to obtain an accurate pressure solution on a coarse grid, and (2) nesting the coarse-grid solutions into a fine grid to obtain detailed pressures that honor the course-grid pressures. The equations of the Weber method are preferred because its improved mathematics is a significant factor in faster and more accurate solutions of the pressure equation, the most time consuming step in reservoir simulation.³

### The Reservoir Description

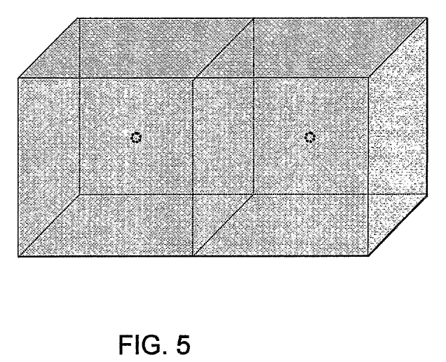

In reservoir simulation, the primary concern is movement of gas, oil, and water in the reservoir.⁴ These fluids flow as a result of the pressure variations in the reservoir. Hence, the prediction of reservoir pressures is necessary. In the present exemplary implementation of the Hardy method, the reservoir geometry was considered as shown in FIG. 5. Injection at 1,500 psi occurs in one well; production at −1500 psi occurs in the other well. The two wells are centered, one in each of the two cubic elements comprising the three-dimensional rectangular reservoir. The boundary conditions of the reservoir are no flow, i.e. the pressure gradients in the direction normal to the boundaries are zero.

The dimensions of the reservoir are in the following ratio: 1×1×2. Reservoir pressures are independent of the actual reservoir dimensions. In this scale, the well radii are 0.0025. Although there are no gravity effects, the reservoir was considered to lie with its largest dimension in the horizontal plane.

The pressure equation is written in terms of average pressure for the conservation of mass flowing through porous material. The incompressible, three-dimensional pressure in a reservoir for which the mobility is everywhere uniform, is given by the Laplace equation:

$$\frac{{\partial }^{2} P}{\partial {x}^{2}} + \frac{{\partial }^{2} P}{\partial {y}^{2}} + \frac{{\partial }^{2} P}{\partial {z}^{2}} = 0 \qquad ( II \text{-} 1 )$$

### Testing the Performance of Various Solvers as a Function of Grid Size.

This study was initialized by considering the performance of various numerical methods for the solution of systems of linear algebraic equations as a function of grid size on a standard desktop computer. The computer used contained an Intel® Pentium® processor with 4 CPU's, 1.80 GHz, and 654.832 meg of RAM. In the entire study, swapping RAM data to the hard drive was not apparent. Hence similar results would be expected on any computer with sufficient memory to avoid swapping.

Both direct and iterative methods were considered and compared. The performance metrics included convergence time, iterations required to converge, and run-time memory requirements.

To study the performance of the various linear algebraic solvers as a function of grid size, a range of test grid sizes was selected. The grids were constructed to permit an anti-symmetric solution around the two wells (injector and producer). Table I summarizes the various grid sizes used.

TABLE I
Grid Sizes and Dimensions

| GRID SIZE | GRID DIMENSIONS |
|---|---|
| 250 | 5 × 5 × 10 |
| 686 | 7 × 7 × 14 |
| 1458 | 9 × 9 × 18 |
| 2662 | 11 × 11 × 22 |
| 9826 | 17 × 17 × 34 |
| 18522 | 21 × 21 × 42 |
| 71874 | 33 × 33 × 66 |
| 101306 | 37 × 37 × 74 |
| 265302 | 51 × 51 × 102 |
| 549250 | 65 × 65 × 130 |
| 986078 | 79 × 79 × 158 |

### Direct Methods

It is well known that direct solution methods perform very well for small grids, but require excessive computational effort and computer memory as the number of grid points increase.⁵ It was anticipated that direct methods might be preferable for the course-grid solution, while iterative methods might be required for the fine grid. The direct elimination methods analyzed were Gauss Elimination⁵, the Doolittle LU factorization method⁵, and a band solver DGBSV from the LAPACK library.⁶ The programs were developed using Compaq Visual Fortran 6.6.

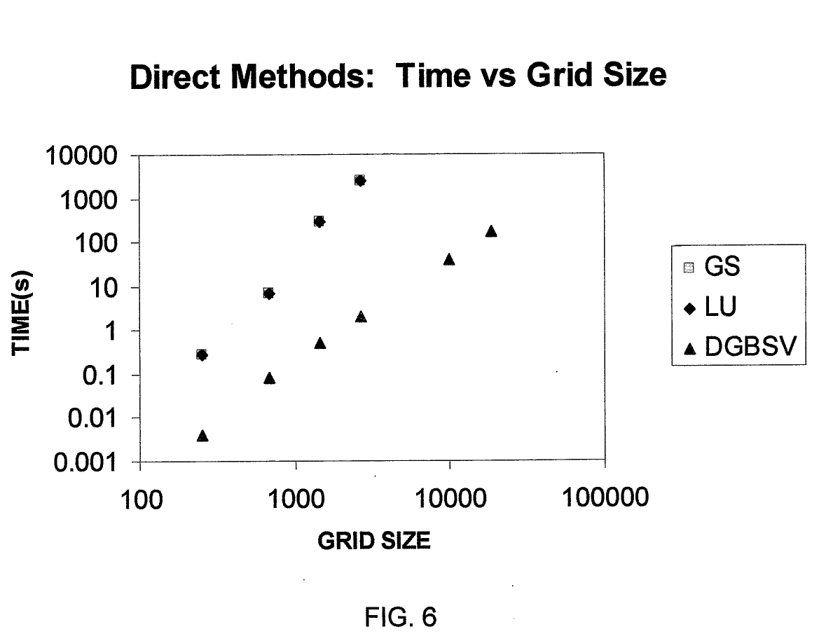

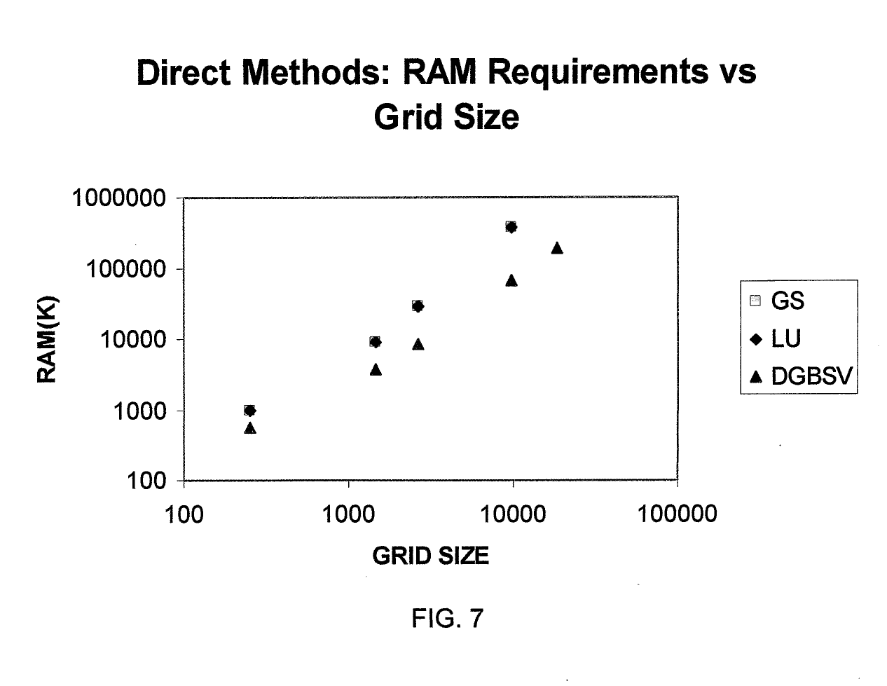

FIG. 6 shows a plot of the direct methods' performance as indicated by convergence time for smaller grid sizes. Indeed, these methods proved to work reasonably well on small grids, yet the bigger grid sizes required large amounts of memory and numerous calculation steps. The direct methods eventually became impractical for the larger grids. For example, an 11×11×22 grid results in 11*11*22=2,262 equations in 2,262 unknowns and a full coefficient matrix with (2262)²=7,086,244 array elements. For the Gauss Elimination and Doolittle LU factorization programs, the next largest grid size considered, 17×17×34, has an input array of 96,550,276 elements and would have taken an estimated four and a half days to compute using 378544 K of RAM. The banded solver from the LAPACK library showed some improvement in performance but still struggled on larger grids. The memory requirements for the direct methods are shown in FIG. 7. These trends were expected, yet the study was conducted for comparative purposes and to aid in the understanding of the solution process.

### Iterative Methods

Some iterative methods require diagonal dominance to guarantee convergence and in general are less robust than direct solvers. The system of equations arising from the seven-point, second-order approximation of the Laplace equation used in this simulation is always diagonally dominant. Hence, it was anticipated that iterative solvers might work well. Several standard iterative methods were considered, namely Jacobi, Gauss-Seidel, and Successive-over-relaxation (SOR). Five advanced iterative methods from MATLAB 7.07 and a hybrid of direct and iterative methods, line successive-over-relaxation (LSOR), were also considered. These iterative methods were better suited for the large systems of equations required in this study. The computer programs for these solvers, other than the five found in MATLAB, were developed in-house with the incorporation of the Thomas algorithm from the LAPACK library for LSOR. The in-house programs were developed in Compaq Visual Fortran 6.6.

For any iterative method, an initial approximation must be made for P_{i,j,k} to start the process. Several choices are available: (1) Simply let P_{i,j,k}=0.0 at all non-specified points. (2) Approximate P_{i,j,k} by some average of the well pressures, or (3) Construct a solution on a course grid, and then interpolate the starting values of the fine grid.⁵ For most of this study, the initial P_{i,j,k} array was set to 0.0 everywhere, except at the wells, which is also the average of the well pressures, 1500 and −1500. However, later in the study, tri-linear interpolation was used to establish starting values for the find grid, the third option mentioned above.

The iterative process terminates when it meets a specified convergence criterion. In general, the number of iterations required to satisfy the convergence criterion is influenced by diagonal dominance, method of iteration, initial solution vector, and the convergence criterion itself. The convergence criterion used by the in-house iterative methods in this study is described by the following equation.

|P_{1,1,1}+P_{Imax,Imax,Kmax}|≦10⁻⁶ (II-2)

P_{1,1,1} and P_{Imax,Jmax,Kmax} are the values of the pressures at opposite corner points of the grid furthest from each other. Since the pressures all started at zero and relax to their solution values asymptotically, with points near the wells changing most rapidly, this convergence criteria should represent the maximum error in the solution after many iterations.
For the methods of SOR and LSOR, another key factor in the determination of the number of iterations required for convergence was the value of the over-relaxation factor, ω. When ω equals one, SOR yields the Gauss-Seidel method. When ω is greater than one, but less than two, the system is over-relaxed; when the ω factor is equal to or greater than two, the system becomes unstable. The relaxation factor does not change the final solution since it multiplies the residual, which is zero when the final solution is reached. The major difficulty with the over-relaxation method is the determination of the best value for ω. In general, the optimal value of the over-relaxation factor ωₒₚₜ depends on the size of the system of equations and the nature of the equations. As a general rule, larger values of ωₒₚₜ were associated with larger systems of equations.⁵ The optimum value of ω was determined by experimentation for the various grid sizes considered in this study.

### MATLAB 7.0 Iterative Methods

MATLAB is a high-performance language for technical computing; the name stands for matrix laboratory. MATLAB incorporates LAPACK and BLAS libraries in its software for matrix computation. Nine functions are available in MATLAB that implement advanced iterative methods for sparse systems of simultaneous linear systems. Of these nine, five where considered: biconjugate gradient (BICG), biconjugate gradient stabilized (BICGSTAB), LSQR implementation of Conjugate Gradients on the Normal Equations (LSQR), generalized minimum residual (GMRES), and quasiminimal residual (QMR). These algorithms were implemented without preconditioners; the magnitude of the convergence tolerance was 10⁻⁶.

### Results

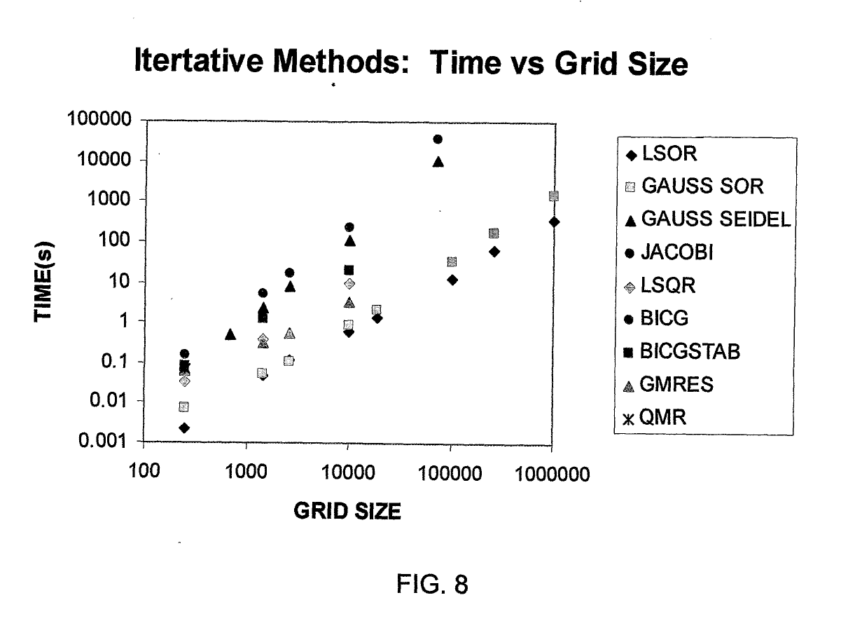

The iterative methods were tested at various grid sizes. Of the iterative methods, LSOR was found to have the best convergence-time performance with SOR following closely. Of the five MATLAB iterative methods GMRES and LSQR were shown to have the best convergence-time performance. FIG. 8 shows the time performance of the various solvers. From this plot it appears that GMRES might eventually perform better than any of the methods. The slope from the two largest grid sizes indicates that this is not the case, but that it would be everywhere slower than SOR and LSOR. Using the four data points for GMRES gives a slope that would indicate better performance for GMRES at larger grids. Given the trends of the other iterative methods, it was decided to base decisions for GMRES off of the data for the two larger grid sizes. QMR and BICG were stable for only the smallest grid size and had comparable convergence times to the other MATLAB iterative methods at this gird size. BICSTAB was shown to be the slowest of the five MATLAB iterative methods. SOR and LSOR performed better than all of the iterative methods; LSOR had slightly better convergence times than SOR, but demanded more RAM than the other in-house iterative methods for all grid sizes. MATLAB did not display how much memory was used as the routines were in progress, but for grid sizes larger than 17×17×34 the desktop computer did not have enough memory to complete the solution for any of the MATLAB methods. As expected, Jacobi and Gauss Seidel iterative methods performed poorly with respect to the other methods when comparing convergence time.

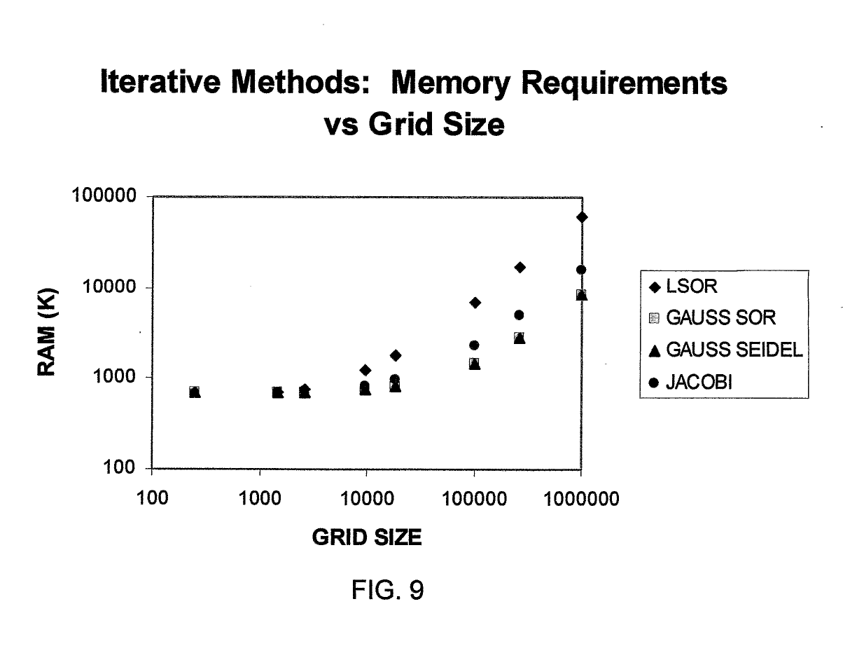

The results of the performance of the various iterative methods are summarized in FIGS. 8 and 9. The values of time and memory shown for SOR and LSOR are at ωₒₚₜ. Memory requirements for MATLAB iterative methods were not determined.

### Determination of the Best Solver

Successive-over-relaxation became the method of choice for the next phase of the study, as its convergence time performance was similar to LSOR and its memory requirements were much lower. Work was done with the LSOR routine to implement the nested-grid method, but the results showed little overall improvement to the speedup of the solution. This may result from the combined direct and iterative methods that are incorporated into its solver routine. Due to memory constraints the MATLAB iterative methods were not considered for the nested-grid method.

### Implementation of the Solver in the Nested-Grid Method

Grid Geometries and General Set Up

For the study of direct and iterative solvers, various grid sizes were utilized as shown previously in Table I. For the nested-grid study, only the fine-grid sizes that resulted in grid points coincident with the course grids were used. Table II shows the grids used.

TABLE II
Grid Sizes Used in Nested-Grid Study

| GRID SIZE | GRID DIMENSIONS |
|---|---|
| 250 | 5 × 5 × 10 |
| 1458 | 9 × 9 × 18 |
| 9826 | 17 × 17 × 34 |
| 71874 | 33 × 33 × 66 |
| 549250 | 65 × 65 × 130 |

For a given fine-grid size, the number of coarse-grid points imbedded in the three-dimensional array varied from a low concentration to a high concentration through various grid refinements. The number of coarse-grid points in the fine grid increased by dividing a given-coarse grid space into four new coarse-grid spaces repetitively until the desired number of coarse-grid points was fixed into the fine-grid solution. The course-grid points were equally distant from one another within the fine grid, and in the two reservoir halves they were symmetrical. At all times, the structure of the fine grid was not changed. The value of the coarse-grid pressure solutions were imbedded into the fine grid such that the previous zero initial value of the fine grid was permanently replaced by the value of the coarse-grid pressure in that particular location throughout the iteration process. For example, in the 1×1 dimension, the number of fixed points after one grid refinement became 4, and in the 1×2 dimension the number of fixed-grid points became 8. In three dimensions these numbers equate to a total of 16 fixed coarse-grid points embedded within the fine grid after one coarse-grid refinement. After the next refinement, there would be 128 coarse-grid points fixed in the fine-grid solution. The formula below indicates the number of fixed points in the 3D simulation depending on the number of grid refinements “n” desired.

Number of Coarse Grid Points=2^{3·n+1} (II-3)

The greatest coarse-grid refinement depended on the fine grid in which the coarse grid was being placed. Refinement of the coarse grid was continued until, for the given fine-grid size, further refinement would result in the coarse grid not being aligned properly with the fine grid. Table III shows the coarse and fine grid sizes selected for the study, the number of fine-grid points between the course-grid points, and the percentage of coarse-grid points compared to the total number of fine-grid points. The number of coarse-grid points does not include the two wells that are part of the original problem.

TABLE III
Nested Grid Geometric Setups

| | | | NUMBER OF FINE | |
|---|---|---|---|---|
| | | | GRID POINTS | PERCENT |
| FINE GRID | | COARSE GRID | BETWEEN COARSE | OF FIXED |
| DIMENSIONS | FINE GRID SIZE | SIZE | GRID POINTS | POINTS |
| 5 × 5 × 10 | 250 | 16 | 1 | 6.4000 |
| 9 × 9 × 18 | 1458 | 16 | 3 | 1.0974 |
| 17 × 17 × 34 | 9826 | 16 | 7 | 0.1628 |
| 33 × 33 × 66 | 71874 | 16 | 15 | 0.0223 |
| 65 × 65 × 130 | 549250 | 16 | 31 | 0.0029 |
| 9 × 9 × 18 | 1458 | 128 | 1 | 8.7791 |
| 17 × 17 × 34 | 9826 | 128 | 3 | 1.3027 |
| 33 × 33 × 66 | 71874 | 128 | 7 | 0.1781 |
| 65 × 65 × 130 | 549250 | 128 | 15 | 0.0233 |
| 17 × 17 × 34 | 9826 | 1024 | 1 | 10.4213 |
| 33 × 33 × 66 | 71874 | 1024 | 3 | 1.4247 |
| 65 × 65 × 130 | 549250 | 1024 | 5 | 0.1864 |
| 33 × 33 × 66 | 71874 | 8192 | 1 | 11.3977 |
| 65 × 65 × 130 | 549250 | 8192 | 3 | 1.4915 |
| 65 × 65 × 130 | 549250 | 65536 | 1 | 11.9319 |

Calculation of the Coarse-Grid Pressure

The above data indicates that a good method to implement for the nested-grid study was the iterative method of Successive-over-relaxation (SOR). The SOR technique determined the coarse-grid pressure values at a predetermined optimal over-relaxation factor. Coarse-grid pressures were extracted from a full fine-grid solution generated at a convergence criterion of 10⁻⁹. This stringent criterion was selected so that errors would not influence the convergence of the final fine-grid solution when the coarse-grid points were embedded. For each fine-grid size, various course-grid solutions were developed at multiple levels of coarse-grid refinement. The very accurate fine-grid solution values were used to represent pressures that would be obtained by using the new finite-difference equations that incorporate the physics of the flow. In practice this method is taking selected accurate answers from the fine-grid solution to represent the coarse-grid values and using them to generate the fine-grid solution again. This may be seen as using select parts of the answer to generate the answer again, yet this is exactly what the new finite-difference equations of the Weber method permit. The new finite-difference equations allow a solution that is accurate on a coarse grid to be embedded into a finer grid to obtain, in a rapid manner, the final solution at fine-grid resolution.

Calculation of the Fine-Grid Pressure

With the coarse-grid solution determined, the accurate course-grid pressures were fixed into the fine-grid solution. For each of the grid setups, an optimal ω was determined with an anti-symmetric convergence criterion of 10⁻⁶, as described by Equation 1, using the SOR iterative method. Notable decreases in calculation times at the newly determined ωₒₚₜ for the nested grid were observed. Table IV shows the results of the nested-fine-grid calculations by displaying ωₒₚₜ, iterations required for convergence, time required for convergence, and ratio of time per iteration for the various grid setups. These data determine an optimal number of fixed-coarse-grid points to accelerate convergence.

TABLE IV
Fine and Nested-Grid Results

| N_{FG} | N_{CG} | ωₒₚₜ | N_{ITER} | TIME(s) | TIME/ITER |
|---|---|---|---|---|---|
| 250 | 0 | 1.800 | 82 | 0.007 | 8.61E−05 |
| 1458 | 0 | 1.910 | 255 | 0.086 | 3.36E−04 |
| 9826 | 0 | 1.968 | 546 | 1.179 | 2.16E−03 |
| 71874 | 0 | 1.988 | 1104 | 33.562 | 3.04E−02 |
| 549250 | 0 | 1.996 | 3356 | 881.925 | 2.63E−01 |
| 250 | 16 | 1.490 | 32 | 0.003 | 1.41E−04 |
| 1458 | 16 | 1.780 | 58 | 0.019 | 3.24E−04 |
| 9826 | 16 | 1.910 | 182 | 0.410 | 2.19E−03 |
| 71874 | 16 | 1.969 | 483 | 15.328 | 3.26E−02 |
| 549250 | 16 | 1.989 | 902 | 242.160 | 2.68E−01 |
| 1458 | 128 | 1.460 | 37 | 0.019 | 9.54E−05 |
| 9826 | 128 | 1.751 | 79 | 0.191 | 2.42E−03 |
| 71874 | 128 | 1.912 | 212 | 7.081 | 3.40E−02 |
| 549250 | 128 | 1.971 | 533 | 145.910 | 2.74E−01 |
| 9826 | 1024 | 1.410 | 35 | 0.082 | 2.87E−03 |
| 71874 | 1024 | 1.770 | 85 | 2.941 | 3.45E−02 |
| 549250 | 1024 | 1.920 | 257 | 73.582 | 2.92E−01 |
| 71874 | 8192 | 1.430 | 35 | 1.223 | 3.46E−02 |
| 549250 | 8192 | 1.760 | 94 | 28.425 | 2.99E−01 |
| 549250 | 65536 | 1.430 | 37 | 12.160 | 3.28E−01 |

Regression of the results in Table IV allowed the generation of mathematical expressions to predict ωₒₚₜ and the number of iterations required for convergence of any nested-fine-grid setup. Both of the expressions were functions of the number of fixed-coarse-grid points (N_{CG}) and the total number of fine-grid points (N_{FG}).

The following correlation predicts the optimal value of ω.

ωₒₚₜ=2−[2.58·(N_{CG})^{0.51}·(N_{FG})^{-2.57}·(N_{FG}−N_{CG})^{2.04}] (II-4)

For the cases studied, this correlation was found to predict ωₒₚₜ value with a correlation coefficient of 0.999 or R² value of 0.998.

The expression for the number of iterations required to solve the pressure equations to a tolerance of 10⁻⁶ at ωₒₚₜ is as follows.

N_{Iter}=7.94·(N_{CG})^{-0.52}·(N_{FG})^{0.39}·(N_{FG}−N_{CG})^{0.10} (II-5)

The correlation coefficient for this expression was 0.995 which is equivalent to a R² value of 0.990.

Optimization of the Nested Grid Method

Simulation runs for various grid sizes at different levels of coarse-grid refinement identified optimal performance of the nested-grid method. A plot of the ratio of time/iteration was made as a function of the total grid size. The time/iteration was found to vary more or less directly with the total number of fine-grid points. This observation was used in the development of a mathematical expression that generated a dimensionless time value which in turn could be used to determine the optimal number of fixed-coarse-grid points for a given fine grid. The expression for the total dimensionless time was.

t_{d}=N_{CG}·N_{Iter}(2,N_{CG})+N_{FG}·N_{Iter}(N_{CG},N_{FG}) (II-6)

As evident, the expression is made of up two parts. The time required for the calculation of the coarse grid with two wells, and the time required for the calculation of the nested-fine-grid solution with two wells. The number of iterations Niter is a function of the number of nested-coarse-grid points and the total number of fine-grid points. For the coarse-grid dimensionless time calculation, the number of iterations is a function of the number of wells (nested-coarse-grid points) and the number of coarse-grid points (in this case, the number of coarse-grid points is equivalent to the total number of fine-grid points). The time required for the calculation of the coarse and fine grid solution is the product of the number of coarse or fine grid points and the number of iterations. The sum of these two yields the total dimensionless time. This function for dimensionless time was optimized by determining the optimum number of fixed-coarse-grid points that should be nested in a given fine-grid solution.

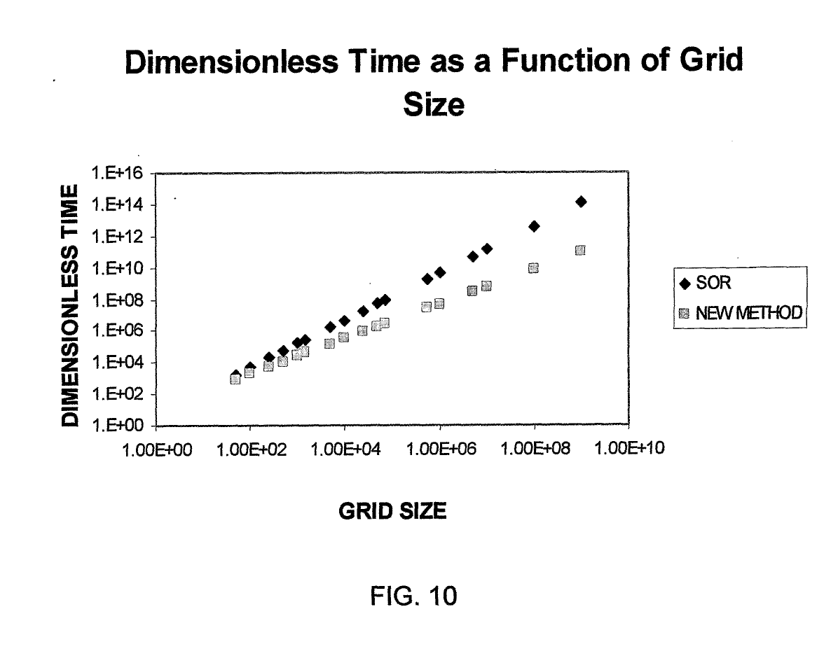

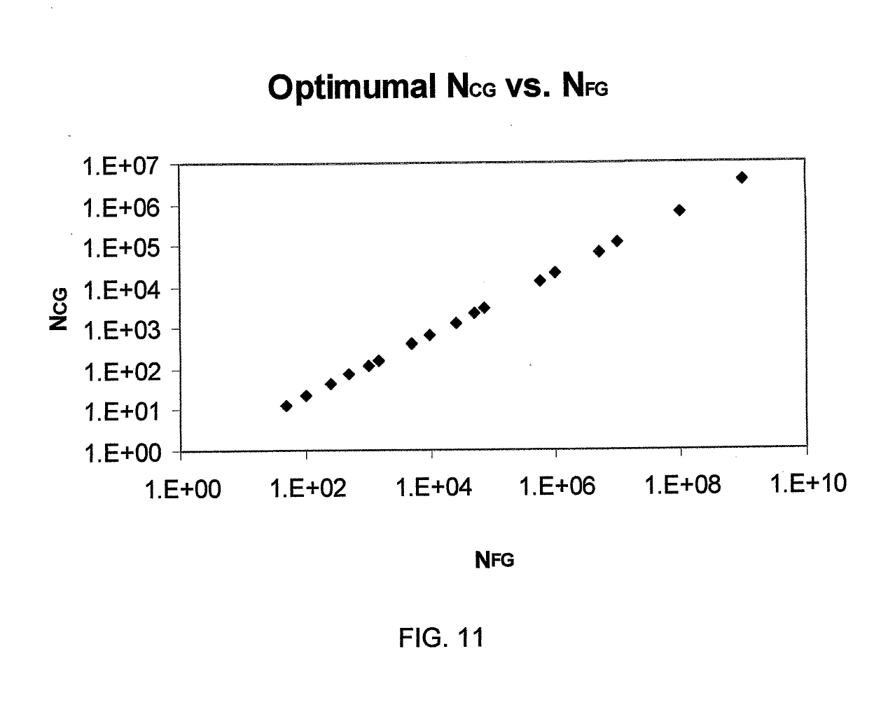

The optimized results indicate significant improvement for larger grids. FIG. 10 shows a plot of the improvement obtained by the nested-grid method compared to the original full solution without fixed points solved using SOR at ωₒₚₜ. Table V summarizes the data displayed in FIG. 10 and shows the ratio of improvement obtained by using the nested-grid method. A plot of the optimum number of coarse-grid points as a function of the number of fine-grid points is shown in FIG. 11. For a grid size of one million, an improvement of 88 times is noted for the optimized-nested-fine-grid solution over the full solution on a fine grid solved with SOR. Extrapolating the data to one billion points yields an improvement of 1256 times. This assumes that the computer being used can handle such large memory demands. The desktop used in this study cannot.

TABLE V
Dimensionless Time Results of Nested-Grid Method

| OPTIMAL N_{CG} | N_{FG} | FULL TIME | OPTIMAL TIME | RATIO |
|---|---|---|---|---|
| 13 | 5.00E+01 | 1.83E+03 | 9.18E+02 | 2 |
| 22 | 1.00E+02 | 5.12E+03 | 1.98E+03 | 3 |
| 43 | 2.50E+02 | 1.99E+04 | 5.44E+03 | 4 |
| 71 | 5.00E+02 | 5.58E+04 | 1.17E+04 | 5 |
| 119 | 1.00E+03 | 1.56E+05 | 2.51E+04 | 6 |
| 157 | 1.46E+03 | 2.73E+05 | 3.80E+04 | 7 |
| 390 | 5.00E+03 | 1.70E+06 | 1.47E+05 | 12 |
| 643 | 9.83E+03 | 4.62E+06 | 3.10E+05 | 15 |
| 1284 | 2.50E+04 | 1.85E+07 | 8.64E+05 | 21 |
| 2144 | 5.00E+04 | 5.16E+07 | 1.85E+06 | 28 |
| 2805 | 7.19E+04 | 8.85E+07 | 2.76E+06 | 32 |
| 12635 | 5.49E+05 | 1.81E+09 | 2.58E+07 | 70 |
| 19688 | 1.00E+06 | 4.39E+09 | 4.98E+07 | 88 |
| 64813 | 5.00E+06 | 4.78E+10 | 2.92E+08 | 164 |
| 108277 | 1.00E+07 | 1.34E+11 | 6.25E+08 | 214 |
| 595596 | 1.00E+08 | 4.06E+12 | 7.84E+09 | 518 |
| 3474824 | 1.00E+09 | 1.24E+14 | 9.85E+10 | 1256 |

For all of the nested-grid set ups, it was determined that at the optimal number of fixed-coarse-grid points the calculation of the coarse-grid pressures takes about 26% of the total time, with the nested-grid-calculation taking the remainder of the time.

The nested-grid method speeds up the calculation of the finely gridded reservoir pressure distribution and makes feasible the simulation of larger grids on standard desktop/laptop computers.

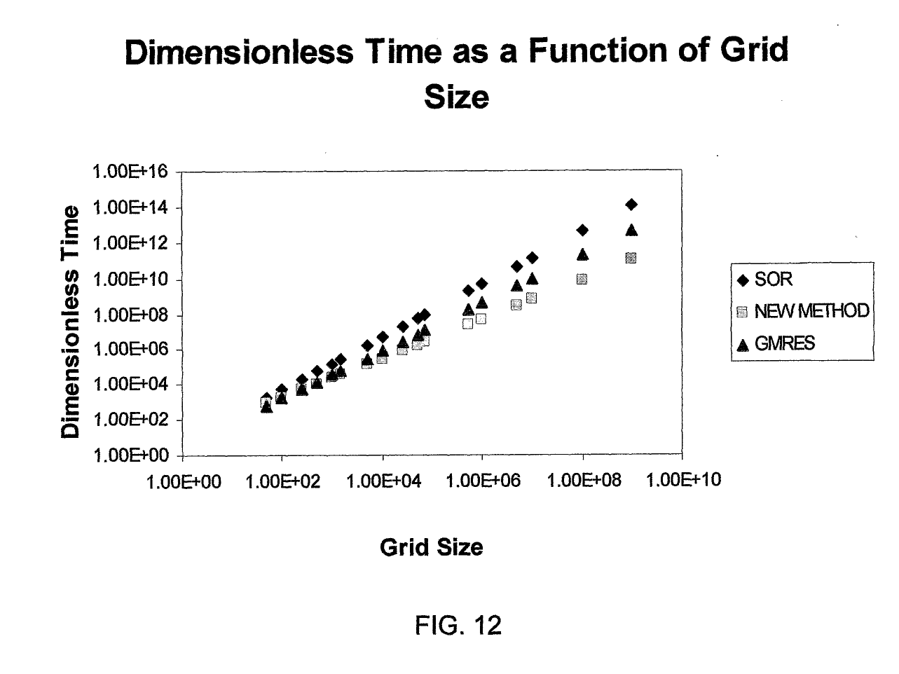

A similar study was done to compare the performance of GMRES with the Hardy method. Once again, basing all analysis for GMRES off of two data points brings into question the feasibility of these values, yet the study was conducted nonetheless. The results are displayed in FIG. 12 and show that for larger grids the Hardy method outperforms GMRES by 8 times for a grid size of one million and by 44 times for a grid size of one billion. For smaller grid sizes their performances are comparable.

### Consideration of the Potential Value of Applying Interpolated Values for Initial Approximation of Pressure Solution

As mentioned previously, for iterative methods an initial approximation needs to be made. In an effort to speed up the solution method further, a three dimensional linear interpolation of the nested-fine-grid set up was computed. Previously the starting values for the calculation were the pressure values for the nested-coarse-grid points, the values of the wells, and everywhere else zero. By interpolating the values of the accurate-fixed points over the zero starting values, it was hoped that the subsequent speedup would be significant. The interpolation program came from the literature.⁸

As shown in Table VI, the results of the interpolation program did not show a significant amount of improvement. In fact, it was evident in many cases that the time required to generate an interpolated solution took longer than the time to simply run the full-fine-grid simulation. This is shown in the last column of Table VI where the value displayed is the ratio of the time required for interpolation divided by the time to run the full-fine-grid solution without fixed-coarse-grid points.

TABLE VI
Interpolation Study

| | | INTERP. | FULL GRID | |
|---|---|---|---|---|
| N_{FG} | N_{CG} | TIME (s) | TIME (s) | RATIO |
| 250 | 0 | | 7.06E−03 | |
| 1458 | 0 | | 8.56E−02 | |
| 9826 | 0 | | 1.18E+00 | |
| 71874 | 0 | | 3.36E+01 | |
| 549250 | 0 | | 8.82E+02 | |
| 250 | 16 | 1.32E−02 | 3.16E−03 | 4.20 |
| 1458 | 16 | 4.82E−02 | 1.90E−02 | 2.53 |
| 9826 | 16 | 5.70E−01 | 4.10E−01 | 1.39 |
| 71874 | 16 | 1.53E+01 | 1.53E+01 | 1.00 |
| 549250 | 16 | 3.72E+02 | 2.42E+02 | 1.54 |
| 1458 | 128 | 4.42E−02 | 1.93E−02 | 2.29 |
| 9826 | 128 | 3.31E−01 | 1.91E−01 | 1.73 |
| 71874 | 128 | 7.37E+00 | 7.08E+00 | 1.04 |
| 549250 | 128 | 1.31E+02 | 1.46E+02 | 0.90 |
| 9826 | 1024 | 2.16E−01 | 8.18E−02 | 2.65 |
| 71874 | 1024 | 3.52E+00 | 2.94E+00 | 1.20 |
| 549250 | 1024 | 6.99E+01 | 7.36E+01 | 0.95 |
| 71874 | 8192 | 1.77E+00 | 1.22E+00 | 1.44 |
| 549250 | 8192 | 2.09E+01 | 2.84E+01 | 0.73 |
| 549250 | 65536 | 1.18E+01 | 1.22E+01 | 0.97 |

### CONCLUSION

The nested-grid method dramatically improves the speed at which a solution on the fine grid can be generated, especially for larger grids. Significant to its success are the Weber finite-difference equations that incorporate the physics of the flow and the placement of an optimal number of coarse-grid points into the fine grid. This exemplary implementation demonstrates that the Hardy method for the determination of the finely gridded reservoir pressures is successful.

### Nomenclature

n=level of grid refinement which determines the number of coarse-grid points
N=quantity of a particular variable
P=pressure
r=radial distance from well center
x,y,z=Cartesian coordinate distances

### Greek

ω=over-relaxation factor

### Subscripts

opt=optimum value
CG=coarse-grid points
FG=fine-grid points
Iter=iterations
d=dimensionless
i,j,k=grid point location in x,y,z respectively

### Section III Streamline Simulation With Dynamic Gridding (Bundy Method)

The illustrative implementation in the description below represents an exemplary prototype streamline reservoir simulator with a dynamic grid, finite difference solution for the saturations along the streamlines. It features increased speed, accuracy, and versatility by incorporating three new technologies: 1) finite difference equations that incorporate the physics of the flow around the wells, 2) streamline simulation, and 3) dynamic gridding. The method rigorously accounts for gravity, capillary pressure and all other phenomena that can be incorporated into traditional, non-streamline, finite difference equations.

The utility of the new Bundy reservoir simulation has been demonstrated with both one- and two-dimensional simulations. The accuracy of the dynamic grid has been shown by comparing the results of a one-dimensional, two-phase, homogeneous, waterflood, with the analytical solution, and with a traditional fixed grid solution. The dynamic grid was found to be more than twice as accurate. A two-dimensional, two-phase, two-well, homogeneous, waterflood, demonstrates the combined technologies. Although there is no analytical solution for this problem from which to assess its accuracy, the details of the flood that can be seen suggest a greatly enhanced accuracy. These details include circular saturation contours at early times, and smooth streamlines. The simulation also shows irregularities in the saturation contours consistent with the meta-stability of the interface that is expected at a mobility ratio of 1.0.

As already stated, this exemplary implementation illustrates a preferred aspect of the invention that combines new techniques for reservoir simulation to create a simulation algorithm that is potentially faster and more accurate than existing methods. In addition, since it employs only finite difference methods, it is capable of simulating all the phenomena included in traditional finite difference simulators. The three techniques are:

1. New Finite Difference Equations Representing the Pressure Equation.

Finite difference expressions approximating partial derivatives are generally derived using Taylor's series. For example, to obtain the finite difference approximation to the pressure equation, Taylor's series are used to create equations for the reservoir pressure at various grid points. These expressions are then solved simultaneously to obtain expressions for the derivatives. Since Taylor's series are polynomials, this procedure works well when the solution of the partial differential equation is smooth and well behaved. However, when singularities and discontinuities appear in the solution, or when they are very nonlinear, finite differences have a difficult time. Such is the case for the pressure equation where near-singularities appear at the wells. As described in Section I, the finite difference equations can be based on mathematical expressions that incorporate the physics of the process. For the reservoir simulation pressures, they propose the use of fde's based on ln(r) for reservoirs with straight line wells, and 1/r for reservoirs with more complex well geometries. (r is the distance to the well. See Nomenclature.) The ln(r)-based finite difference equation is used in this exemplary implementation. The 1/r equations should be used for more complex well geometries.

Streamline Simulation

Traditional, fully implicit simulators solve for reservoir pressures and saturations simultaneously at all finite difference grid points within the reservoir. The less stable, IMPES formulation separates the two solutions and solves for the pressures at each grid point implicitly, and then takes an explicit timestep to obtain the saturations at each grid point. Some years ago investigators recognized that the instabilities of the IMPES formulation could be overcome by solving for the saturations along the streamlines using an analytical solution based on the Method of Characteristics.^{14,15} This analytical solution also eliminates numerical dispersions, resulting in much sharper and more accurate flood fronts. Since that time, research at the University of Oslo¹⁶ and at Stanford University¹⁷ has results in commercially available streamline simulators.

Streamline models are much faster than traditional fully implicit simulators. They are also faster than IMPES simulators, because they are unconditionally stable, and large timesteps can be taken. When reservoir pressures do not change rapidly, streamline simulations can be made even more rapid by taking several timesteps before recalculating the pressures. However, streamline models are not without limitations. The analytical solution that they apply to get the saturations cannot be achieved when all physical phenomena are included. In particular, capillary pressure cannot be included. Furthermore the inclusion of gravitational effects in heterogeneous systems greatly complicates the analytical solution. Commercial models avoid these complications by employing an approximate, “operator splitting” technique.¹⁸ As illustrated by exemplary implementation, the Bundy method uses the streamline simulation approach, but attempts to overcome the shortcomings of the method by incorporating a dynamic grid, finite difference solution for the saturations on the streamlines.

Dynamic Grid Solution.

Finite difference grids that move as the simulation progresses have been seen as a good idea for some time.¹⁹ However, such techniques have never become widely popular because of the computational overhead required to revise the grid, potentially at every timestep. This description relates to a method of dynamic gridding which has no such overhead. The dynamic spatial grid is created simply by choosing specific saturations and solving the finite difference equations for the location of these saturations. Whereas traditional simulators solve for the saturation at specified grid points. This disclosure shows that this new dynamic grid does result in a fine spatial gridding in the areas of greatest saturation changes, i.e. at the wells and flood fronts. Moreover, the solutions are found to be unconditionally stable. Hence a one-dimensional dynamic grid solution on the streamlines has all the benefits of speed benefits of the analytical streamline solutions, but not the shortcomings. As finite difference equations they can include all the phenomena of traditional simulators, including capillary pressure and gravity.

### Dynamic Gridding.

A dynamic spatial grid is accomplished through the use of a static saturation grid. That is, the finite difference equations representing the saturation equation are solved for the location of specific saturations, rather than for saturations at specific locations, as is usually done.

This approach is relatively simple in one-dimension. The saturation equation,

$$Φ \frac{\partial S}{\partial t} = \frac{\partial }{\partial x} ( \frac{K \cdot {k}_{r}}{μ} \frac{\partial p}{\partial x} ) = 0 \qquad ( III \text{-} 1 )$$

when combined with the incompressible pressure equation

$$\frac{\partial }{\partial x} ( \frac{K \cdot {k}_{rt}}{{μ}_{t}} \frac{\partial p}{\partial x} ) = 0 \qquad ( III \text{-} 2 )$$

becomes

$$Φ \frac{\partial S}{\partial t} = q \frac{\partial }{\partial x} ( \frac{{k}_{r} {μ}_{t}}{{k}_{rt} μ} ) or Φ \frac{\partial S}{\partial t} = q \frac{\partial f}{\partial x} \qquad ( III \text{-} 3 )$$

The classical analytic solution of this equation, achieved with the method of characteristics, is known as the Buckley-Leverett problem:

$$\frac{\partial x}{\partial t} {\vert}_{S} = \frac{q}{Φ} \frac{d f}{d S} or Δ x = \frac{q}{Φ} \frac{d f}{d S} Δ t \qquad ( III \text{-} 4 )$$

The finite difference approximation to Equation 3 yields a expression similar in appearance:

$$Δ x = \frac{q}{Φ} \frac{Δ f}{Δ S} Δ t \qquad ( III \text{-} 5 )$$

However, in this expression Δf is the difference between the fractional flow values at consecutive saturation grid points, Sᵢ and Sᵢ₊₁, i.e. Δf=fᵢ₊₁−fᵢ. ΔS is the difference in saturations at the same point is space but at consecutive timesteps, i.e. ΔS=Sₙ₊₁−Sₙ. Another similarity of Equations 4 and 5 is that they are both unconditionally stable. That is, regardless of the time step size, they yield physically plausible solutions. On the other hand, if Equation 3 had been finite differenced and solved for ΔS at various grid points in space, predicted saturation values would oscillate wildly at large timesteps. A dissimilarity of the equations is that Equation 5 automatically predicts the location of the flood front, whereas a separate calculation must be made to locate it with Equation 4.

In multi-dimensions this dynamic gridding approach becomes much more flexible and potentially complicated. In 2-D there is no single point that defines the location of a particular saturation. Instead there is whole line of points. In 3-D, there is a surface of points. Additional constraints are required to determine how to select a finite set of points defining these lines and surfaces. One might choose particular x's and/or y's; he might choose the points to be equally distant from one another, or he might choose points on the stream lines. The possibilities are endless, but the latter is particularly attractive as a knowledge of the streamlines can be insightful, and Equation 3 is particularly simple when solved on the streamlines^{10,20}

$$\frac{\partial S}{\partial t} = - \frac{\partial f}{\partial τ} \qquad ( III \text{-} 6 )$$

where τ is the travel time along the stream line to reach a particular point or “time of flight”.

Simulator Algorithm

The algorithm for the Bundy reservoir simulation method consists of the following five steps, repeated for each timestep:

Step 1

Calculate the coefficients for the linear algebraic equations comprising the pressure equation. In this exemplary implementation the simple pressure equation,

$$\frac{\partial }{\partial x} ( \frac{{K}_{x} {k}_{rt}}{μ} ) + \frac{\partial }{\partial y} ( \frac{{K}_{y} {k}_{rt}}{μ} ) = 0 \qquad ( III \text{-} 7 )$$

was approximated by

$${C}_{i} ( {P}_{i + 1 , j} - {P}_{i , j )} ) - {C}_{i - 1} ( {P}_{i , j} - {P}_{i - 1 , j )} ) + {C}_{j} ( {P}_{i , j + 1} - {P}_{i , j )} ) - {C}_{j - 1} ( {P}_{i , j} - {P}_{i , j - 1} ) = 0 \qquad ( III \text{-} 8 )$$

where

$$\begin{matrix}{C}_{i} = \frac{\sum Q {\int }_{{y}_{ji} - \frac{Δ y}{2}}^{{y}_{j} + \frac{Δ y}{2}} \frac{{K}_{x} {k}_{rt}}{{μ}_{t}} \frac{x d y}{{x}^{2} + {y}^{2}}}{\sum Q ln ( {r}_{i + 1} ) - \sum Q ln ( {r}_{i} )} and & ( III \text{-} 9 ) \\ {C}_{j} = \frac{\sum Q {\int }_{{x}_{i} - \frac{Δ x}{2}}^{{x}_{i} + \frac{Δ x}{2}} \frac{{K}_{y} {k}_{rt}}{{μ}_{t}} \frac{y d x}{{x}^{2} + {y}^{2}}}{\sum Q ln ( {r}_{j + 1} ) - \sum Q ln ( {r}_{j} )} & ( III \text{-} 10 )\end{matrix}$$

These coefficients are based on finite difference equations derived by assuming a fundamental functional form that includes ln(r)-terms rather than the simple polynomial form that results from the usual Taylor-series-based derivations. Details of the derivation can be found in Section I, and Weber et al. ³, who show several orders of magnitude improvement in the error in calculated pressures. A pressure drop proportional to ln(r) occurs around infinite, straight-line sources and sinks. Hence the ln(r) formulation incorporates the physics of the process in the finite difference equations. For more complex wells, Weber et al. proposes finite difference equations incorporating 1/r-terms.

Step 2

Solve the linear algebraic approximations to the pressure equations, Equation III-2. In this exemplary implementation these equations were solved by simple relaxation. Equation III-2 was solved for P_{i,j}, making each cell's pressure a weighted average of the four neighboring cell pressures. The entire set of P's were solved repeatedly until convergence occurred. This was by far the most time consuming step in the algorithm. A more sophisticated solution technique would greatly improve the speed of the simulator.

Step 3

Locate the streamlines. This was done by calculating the velocity vector of a point on the streamline and then stepping a distance of 0.15 Δx in that direction, or to the edge of the finite difference grid cell, if that distance was less. This first order approach causes a slight asymmetry of the initial stream lines when symmetry across the reservoir bisector would be expected. This error would be reduced by taking smaller steps, i.e. <0.15, or by employing a higher order solution scheme such at Runge-Kutta.

Velocities at each point in the reservoir were calculated from formulae consistent with Weber's 3 (Section I) finite difference equations:

$${v}_{x} = \frac{1}{2 π} \sum \frac{Qx}{{x}^{2} + {y}^{2}} + {a}_{x} \cdot {f}_{x} + {b}_{x} \\ {v}_{y} = \frac{1}{2 π} \sum \frac{Qy}{{x}^{2} + {y}^{2}} + {a}_{y} \cdot {f}_{y} + {b}_{y} \qquad ( III \text{-} 11 )$$

where fₓ and f_{y} are the fractional distances across the finite difference grid cells in the x- and y-directions, respectively, and

$${b}_{x} = - {C}_{i - 1} ( {P}_{i , j} - {P}_{i - 1 , j} ) - \frac{1}{2 π} \sum Q \cdot {Ω}_{W} \\ {a}_{x} = - {C}_{i} ( {P}_{i + 1 , j} - {P}_{i , j} ) - \frac{1}{2 π} \sum Q \cdot {Ω}_{E} - {b}_{x} \\ {b}_{y} = - {C}_{j - 1} ( {P}_{i , j} - {P}_{i - 1 , j} ) - \frac{1}{2 π} \sum Q \cdot {Ω}_{S} \\ {a}_{y} = - {C}_{j} ( {P}_{i , j + 1} - {P}_{i , j} ) - \frac{1}{2 π} \sum Q \cdot {Ω}_{N} - {b}_{y} \qquad ( III \text{-} 12 )$$

Ω_{N}, Ω_{E}, Ω_{S}, and ω_{W} are the angles subtended by the upper (North), right (East), lower (South), and left (West) sides, respectively, of the finite different cell with respect to the well.

In addition to recording the locations of each of the points comprising the streamlines, the time required to reach each point on the streamline, τ, was also calculated:

$$τ = {\sum }_{\begin{matrix}all \\ line \\ segments\end{matrix}} \frac{D}{\sqrt{{v}_{x}^{2} + {v}_{y}^{2}}} \qquad ( 40 )$$

where D is the lesser of 0.15·Δx and the distance to the cell boundary along the streamline.

Step 4

Calculate the intersections of the old saturation contours with the new streamlines, and determine the new τ associated with each intersection. This step is unnecessary on the first timestep as all old saturation contours are coincident with the wellbore, and the τ's of all points are equal to zero. It is also unnecessary if the pressures, and hence the streamlines, are unchanged since the last timestep. Without this step, saturation contours have the same τ everywhere. The algorithm is then even faster as only one 1-D saturation solution applies to all streamlines.

Step 5

Move the saturation contour points down the streamlines to their new-time location. The “time of flight” equation, Equation 6 governs the position of the contour points. In this algorithm, the time of flight τₙ, was found from

$${\int }_{{τ}_{n - 1}}^{{τ}_{n}} Δ S d τ = - Δ f \cdot Δ t \qquad ( III \text{-} 14 )$$

where τₙ₋₁ is the interpolated τ from step 4.

Saturations are assumed to be constant between saturation contours simplifying this equation to

$${τ}_{n} = {τ}_{n - 1} - \frac{1}{{S}_{n} - {S}_{mf + 1}} [ \begin{matrix}Δ f \cdot Δ t + ( {S}_{n - 1} - {S}_{m} ) ( {τ}_{m s} - {τ}_{n - 1} ) + \\ {\sum }_{m = m s}^{mf} ( {S}_{m} - {S}_{m - 1} ) ( {τ}_{m} - {τ}_{m - 1} )\end{matrix} ] . \qquad ( III \text{-} 15 )$$

### One-Dimensional, Dynamic Grid Results.

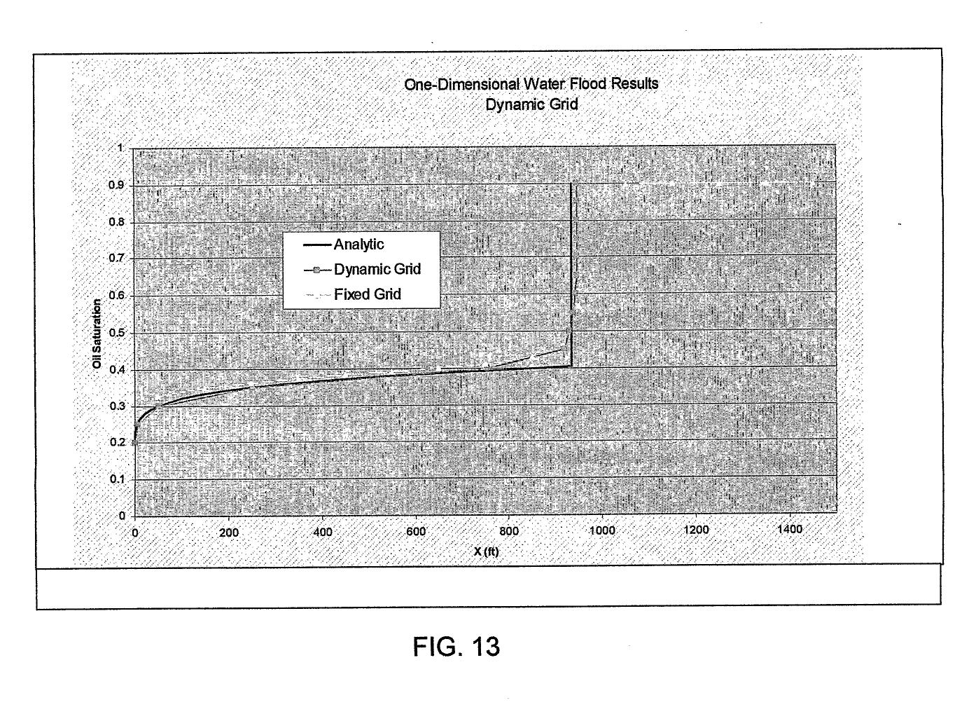

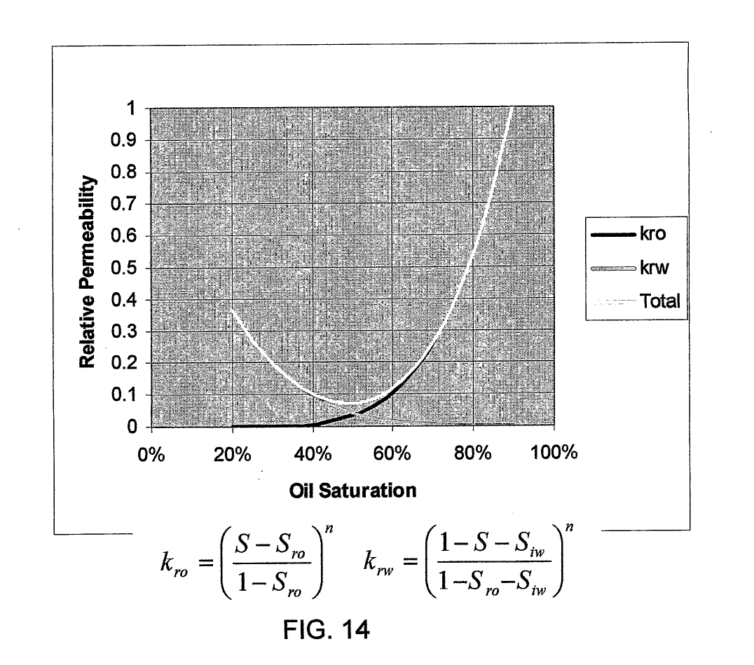

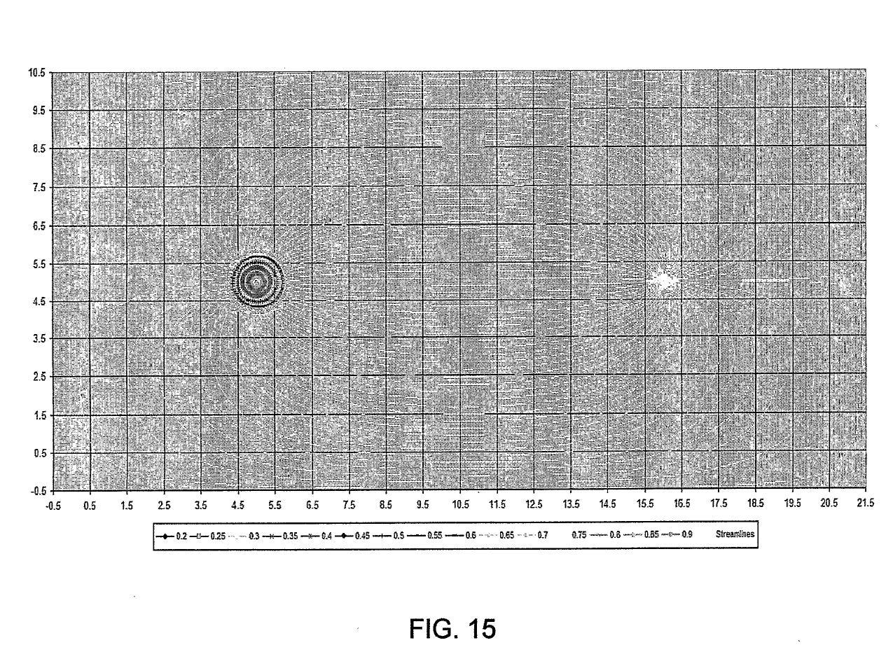

FIG. 13 compares the new dynamic grid technique with the results from the traditional fixed grid solution and the analytical, Buckley-Leverett solution. The relative permeabilities used in these results are shown in FIG. 14. FIG. 15 confirms that a grid based on constant saturation intervals, ΔS=0.05, does create a dynamic spatial grid in which the grid spacing is very small near the well and near the flood front. The solution from the resulting fifteen grid points is a much more accurate than the fifteen grid points equally spaced with Δx=100 ft. Both identically satisfy the material balance.

### Two-Dimensional, Prototype Simulator Results.

FIGS. 15-18 show selected results from a 2-D water flood simulation using the full algorithm described above. The rectangular reservoir contains wells centered in each of two square elements comprising the reservoir, one producer and one injector. The injection pressure is 1,000 psi, the production pressure is −1,000 psi. The Figures show the 11 by 22 finite difference grid used to obtain the pressure solution. They also show the sixty streamlines which emanate from the injection well and terminate at the production well. Finally they show the fifteen constant saturation lines. Again ΔS=0.05.

FIG. 15 shows that the constant saturations lines emerge from the injection well in a nearly circular fashion. These results are intuitively satisfying, but may be surprising to anyone who has simulated with such a course grid using a traditional reservoir simulator. The precision of the circular saturation contours, as well as the smoothness of the streamlines, results from the new Weber¹³ finite difference equations (Section I) that include ln(r)-terms in their formulation.

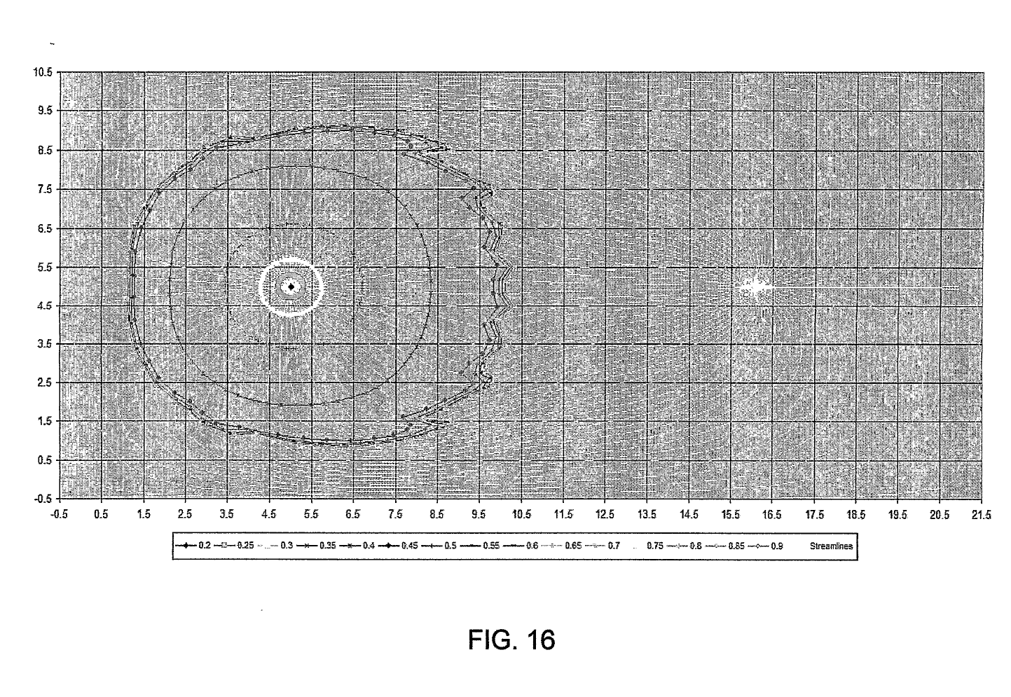

FIG. 16 shows that the dynamic grid solution for saturation on the stream lines provides a sharp flood front. Saturation contours are close together at the leading edge of the flood. The figure also shows that the saturation contours do not remain smooth circles forever. They become somewhat ragged, particularly along the high velocity streamlines that go most directly to the producer. Such irregularities in the contours are consistent with the meta-stability of the interface that one might expect for a mobility ratio of 1.0. These instabilities may be enhanced by the low mobilities that occur at the interface as a result of the highly non-linear relative permeabilities. As the streamlines approach the flood front, they see a very unstable mobility situation: a high mobility fluid fingering into a low mobility fluid. However, as they emerge from the front they see a very stable situation: a low mobility fluid pushing a high mobility fluid. Nevertheless, the frequency of the frontal instabilities, one per finite difference grid block, suggests that the phenomenon is, at least in part, numerically induced. In any case, the details that can be observed from the coarsely gridded simulation are great.

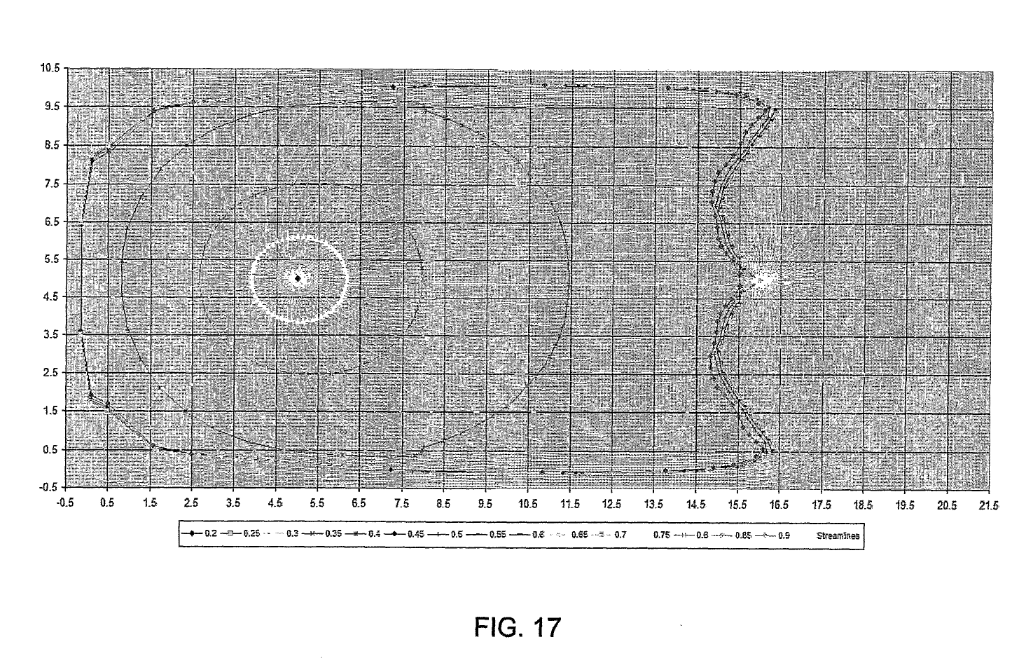

FIG. 17 shows the simulation at breakthrough. It shows that the flood front advances fairly linearly across the reservoir. There is no early breakthrough along streamlines that move directly from the injector to the producer. In fact, the best swept streamlines are not these central streamlines, but those that swing out toward the edge of the reservoir. The maximum movement of the front in the x-direction between wells appears near the edge of the reservoir. This is the result of the large velocities that occur near the edges of the reservoir. The low mobility at the flood front makes the process much like blowing up a balloon in a box. As the front approaches the reservoir boundary, the path for the unswept oil to move from the area behind the injection well and to the production well becomes very narrow. Hence velocities near the boundaries of the reservoir become high.

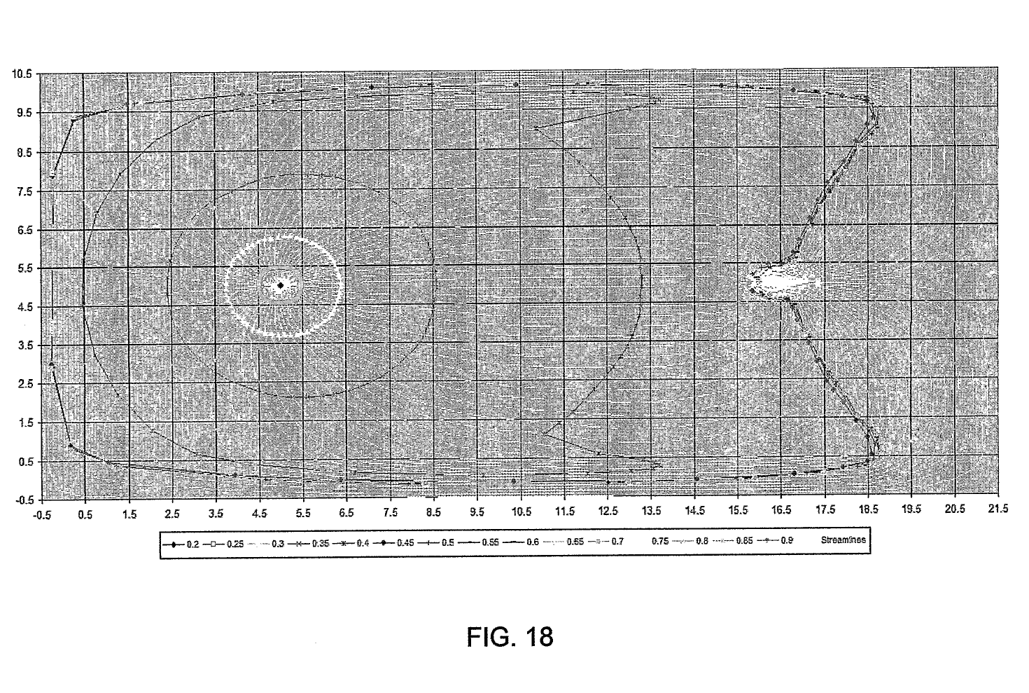

FIG. 18 shows that as the flood front proceeds after breakthrough, there remains a fairly large area behind the producing well that remains unflooded. Single-phase oil flows in this channel at relatively high velocities.

All the FIGS., 15 through 18, show abrupt saturation changes near the flood front. Capillary pressures may be of significance in these areas, particularly where the front enters the producing well. Traditional simulators are fraught with numerical dispersion, and as a result, capillary pressures are not usually significant. In streamline simulators that use an analytical solution on the streamlines, capillary pressures cannot be included. This new Bundy simulation algorithm may be the first with the capability of accurately assessing capillary pressure effects in a field scale simulation.

The present description shows a streamline reservoir simulator with a dynamic grid, finite difference solution for the saturations along the streamlines. It features increased speed, accuracy, and versatility by incorporating three new technologies: 1) finite difference equations, that preferably incorporate the physics of the flow around the wells, 2) streamline simulation, and 3) dynamic gridding. The method rigorously accounts for gravity, capillary pressure and all other phenomena that can be incorporated into traditional, non-streamline, finite difference equations.

The utility of the new Bundy reservoir simulation has been demonstrated with both one- and two-dimensional simulations. The accuracy of the dynamic grid has been shown by comparing the results of a one-dimensional, two-phase, homogeneous, waterflood, with the analytical solution, and with a traditional fixed grid solution. The dynamic grid was found to be more than twice as accurate. A two-dimensional, two-phase, two-well, homogeneous, waterflood, demonstrates the combined technologies. Although there is no analytical solution for this problem from which to assess its accuracy, the details of the flood that can be seen suggest a greatly enhanced accuracy. These details include circular saturation contours at early times, and smooth streamlines. The simulation also shows irregularities in the saturation contours consistent with the meta-stability of the interface that is expected at a mobility ratio of 1.0.

### Nomenclature for Equations in Section III:

a, b=Constants describing the Cartesian components of the velocity, see equations (11) and (12)

C=Coefficients of the linear algebraic, finite difference, equations approximating the pressure equation.

D=Length of a streamline segment.

f=Fractional flow

K=Permeability

kᵣ=Relative Permeability

P=Reservoir Pressure

Q=Total well rate/unit length

q=Total volumetric flux, total flow rate/area

r=Distance to well

S=Saturation

t=Time

v=Velocity

x, y=Cartesian coordinate distances

### Greek

α=Fractional distance across the finite difference grid cell.

Δ=Change in variable, e.g. Δt is timestep size, Δx and Δy are grid dimensions

μ=Viscosity

Φ=Porosity

τ=“Time of flight”, time required to reach a particular point on a streamline

Ω=Angle subtended by the ends of a grid cell relative to the well.

### Subscripts

i=Pertaining to the i-th cell in the x-direction

j=Pertaining to the j-th cell in the y-direction

ms=Pertaining to the first old-time point on a streamline between new-time points n−1 and n.

mf=Pertaining to the last old-time point on a streamline between new-time points n−1 and n.

n=Pertaining to the n-th point on a streamline

N, E, W, S,=Relative to the sides of a grid cell: North (upper), East (left), West (right), and South (lower), respectively.

o=Oil phase

t=Total for all phases

w=Water phase

x=Pertaining to the x-direction

y=Pertaining to the y-direction

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

What is claimed is:

1. A method for simulating pressures and saturations of oil, gas, and water in an oil reservoir with at least one production or injection well, the method comprising:
dividing the reservoir into an array of grid blocks, each block with a permeability and porosity;
generating an approximating set of linear algebraic equations (finite difference equations) to represent partial differential equations governing flow in the reservoir, one equation for each block,
the set of the linear algebraic equations based upon finite difference equations that include ln(r) or 1/r, where r is the distance from a well bore;
solving the set of linear algebraic equations.

2. The method as in claim 1 wherein pressures are assumed to be logarithmic in form by including ln(r), and a resulting finite difference approximation to the first order partial derivative is;
$$\frac{\partial p}{\partial x} = - \frac{( {p}_{i + 1} - {p}_{i} ) \sum \frac{Qx}{{r}^{2}}}{\sum Q ln ( {r}_{i + 1} ) - \sum Q ln ( {r}_{i} )}$$
where Q is well rate, p is pressure and r is radial distance from well center.

3. The method of claim 2 wherein resulting finite difference equations for the reservoir pressures are based on equations of the form,
$${q}_{x} = - \frac{{K}_{x}}{μ} \frac{{p}_{i + 1} - {p}_{i}}{{x}_{i + 1} - {x}_{i}}$$
where the cell permeabilities, K, are multiplied by an expression, forming a pseudo permeability, K′,
$${K}_{x +}^{′} = {K}_{x +} \frac{\sum Q {α}_{x +}}{\sum Q ln ( {r}_{i + 1} ) - \sum Q ln ( {r}_{i} )}$$
where α is the angle in radians swept by the cell face relative to the well.

4. The method as in claim 1 wherein pressures are assumed to be inverse-r in form resulting from a number of point sources, resulting in finite difference approximation to the first order partial derivative:
$$\frac{\partial p}{\partial x} = - \frac{( {p}_{i + 1} - {p}_{i} ) \sum \frac{Qx}{{r}^{3}}}{\sum \frac{Q}{{r}_{i + 1}} - \sum \frac{Q}{{r}_{i}}} .$$

5. The method of claim 4 wherein resulting finite difference equations for the reservoir pressures are based on equations,
$${q}_{x} = \frac{{K}_{x}}{μ} \frac{{p}_{i + 1} - {p}_{i}}{{x}_{i + 1} - {x}_{i}}$$
where the cell permeabilities, K, are multiplied by an expression, forming a pseudo permeability, K′,
$${K}_{x +}^{′} = {K}_{x +} \frac{\sum Q {Ω}_{x +}}{\sum \frac{Q}{{r}_{i + 1}} - \sum \frac{Q}{{r}_{i}}}$$
where Ω is the solid angle in sterradians swept by the cell face relative to the well.

6. The method of claims 1 wherein coefficients of the approximating linear equations only for cells in the immediate vicinity of the wells are calculated by the recited steps, and the coefficients for remaining cells are calculated by finite difference equations based upon polynomials derived from Taylor Series.

7. A method for simulating pressures and saturations of oil, gas, and water in an oil reservoir with at least one production or injection well, the method comprising:
dividing the reservoir into a fine grid array of grid blocks, each block with a permeability and porosity;
defining a coarse grid array with fewer cells than the fine array, wherein the fine grid array is nested within the coarse grid with cell centers points of the coarse grid corresponding to cell center points of the fine grid,
calculating pressure for each cell of the coarse grid array,
fixing the pressure value of fine grid array cells to the solution of corresponding-center-point coarse grid cells,
calculating pressures for cells of the fine grid by an iterative method where the cell pressure values solved by the coarse grid are fixed and not recalculated.

8. The method of claim 7 wherein the coarse grid solution, or the fine grid solution, are solved by a method comprising:
generating an approximating set of linear algebraic equations (finite difference equations) to represent a partial differential equation governing flow in the reservoir, one equation for each block,
the set of the linear algebraic equations based upon finite difference equations that include ln(r) or 1/r, where r is the distance from a well bore:
solving the set of linear algebraic equations.

9. The method of claim 7 wherein the coarse grid is solved by an iterative method or a non-iterative method.

10. A method for simulating pressures and saturations of oil, gas, and water in an oil reservoir with at least one production or injection well, the method comprising:
executing a time-step (n) comprising
dividing the reservoir into an array of grid blocks, each block with a permeability and porosity,
the center points of each block positioned on-constant saturation contours, with the saturation contours being at predetermined intervals;
generating an approximating set of linear algebraic equations (finite difference equations) to represent a partial differential equation governing flow in the reservoir, one equation for each block,
solving the set of linear algebraic equations to calculate a pressure for each block,
calculating the location of the bulkflow streamlines for each block based on the calculated pressures,
calculating the position on the streamline for each block center point were the streamline intersects with a constant saturation contour, and calculating a time (τₙ₋₁), associated with the intersection, where the time (τₙ₋₁) is the travel time within the reservoir from the position of the center point to the intersection position, where τ₀=0,
displacing each center point to a position along the streamline to a new time location and thereby displacing saturation contours, the new time (τₙ) consistent with the relationship
$${\int }_{{τ}_{n - 1}}^{{τ}_{n}} Δ S d τ = - Δ f \cdot Δ t .$$

11. The method of claim 10 wherein the time step is repeated to produce successive time locations.

12. The method of claim 10 wherein time new time (τₙ) is calculated using the approximate equation:
$${τ}_{n} = {τ}_{n - 1} - \frac{1}{{S}_{n} - {S}_{mf + 1}} [ \begin{matrix}Δ f \cdot Δ t + ( {S}_{n - 1} - {S}_{m} ) ( {τ}_{m s} - {τ}_{n - 1} ) + \\ {\sum }_{m = m s}^{mf} ( {S}_{m} - {S}_{m - 1} ) ( {τ}_{m} - {τ}_{m - 1} )\end{matrix} ]$$

13. The method of claim 10 wherein the grid is two-dimensional or three-dimensional.

14. The method of claim 10 wherein the set of the linear algebraic equations based upon finite difference equations that include ln(r) or 1/r, where r is the distance from a well bore;

15. The method of claim 10 additionally comprising after the dividing the reservoir into an array of grid blocks, a step of dividing the reservoir into a coarse grid array with fewer constant saturation contours and with fewer grid points on each contour, wherein the fine grid array is nested within the coarse grid with cell centers points of the coarse grid corresponding to cell center points of the fine grid,
calculating pressure for each cell of the coarse grid array,
fixing the pressure value of previous grid array cells to the solution of corresponding-center-point coarse grid cells,
calculating pressures for cells of the previous grid by an iterative method where the cell pressure values solved by the coarse grid are fixed and not recalculated.
